(19) United States
(12) Patent Application Publication
(10) Pub. No.: US 2025/0327226 A1
(43) Pub. Date: Oct. 23, 2025

(54) ARTICLES OF APPAREL COMPRISING COMPOSITE WOUND COMPONENT AND METHODS OF MAKING THE SAME

(71) Applicant: adidas AG, Herzogenaurach (DE)

(72) Inventors: Sam Conklin, Portland, OR (US); Matteo Padovani, Portland, OR (US); Fionn Corcoran-Tadd, Portland, OR (US); Ian James Hennebery, Portland, OR (US)

(21) Appl. No.: 18/640,605

(22) Filed: Apr. 19, 2024

(51) Int. Cl. D04H 1/645; A43B 23/02; B29D 35/14; D06M 15/55

(52) U.S. Cl. CPC D04H 1/645; A43B 23/0235; B29D 35/142; B29D 35/146; D06M 15/55

(57) ABSTRACT

Articles of apparel and methods of making articles of apparel comprising one or more continuous threads wound around anchor points. In some embodiments, the methods can comprise winding a continuous thread around a plurality of projections to form a thread layer comprising a plurality of thread lines and impregnating at least a portion of the continuous thread with a flowable liquid polymer. In some embodiments, the methods can comprise bonding a thread layer to a rigid plate such that one or more thread lines extend across an opening formed in the rigid plate.

### FIELD

The described embodiments generally relate to articles of apparel and methods of making articles of apparel. In particular, described embodiments relate to articles of apparel comprising a composite material comprising a continuous thread wound in a thread layer or thread pattern.

### BACKGROUND

Apparel can be manufactured from various materials using a wide range of techniques, including weaving and knitting. Individuals are often concerned with the durability, comfort, and/or performance characteristics for an article of apparel. This is true for apparel worn for athletic and non-athletic activities. Proper apparel should be durable, comfortable, and provide other beneficial characteristics for an individual. Therefore, a continuing need exists for innovations in apparel and methods of making apparel to suit individuals across a range of use cases. Particularly, there is a need for methods of making materials for apparel that have customizable characteristics yet can be efficiently manufactured in large quantities and/or sizes.

### BRIEF SUMMARY

A first embodiment (1) of the present application is directed to a method of making an article of apparel, the method comprising: winding a first continuous thread around a plurality of projections to form a first thread layer comprising a plurality of thread lines, with each thread line extending between two respective projections; and impregnating at least a portion of the first continuous thread with a flowable liquid polymer.

In a second embodiment (2), the method according to the first embodiment (1) comprises winding a second continuous thread around a plurality of projections to form a second thread layer, the second thread layer comprising a plurality of thread lines, with each thread line extending between two respective projections.

In a third embodiment (3), the method according to the second embodiment (2) comprises impregnating at least a portion of the second continuous thread with the flowable liquid polymer.

In a fourth embodiment (4), the method according to the third embodiment (3) comprises positioning, after impregnating at least the portion of the second continuous thread with the flowable liquid polymer, a third layer between the first and second thread layers to form a layered structure, the third layer comprising a different material than the first and second thread layers.

In a fifth embodiment (5), the different material according to the fourth embodiment (4) comprises a foam material.

In a sixth embodiment (6), the method according to any one of embodiments (4)-(5) comprises conforming the layered structure to a shape of a mold.

In a seventh embodiment (7), the method according to the sixth embodiment (6) comprises positioning the mold and the layered structure inside a vacuum bag; and removing air from the vacuum bag to bond the first and second thread layers and the third layer to one another via the flowable liquid polymer.

In an eighth embodiment (8), the mold according to any one of embodiments (6)-(7) comprises a shoe last.

In a ninth embodiment (9), the thread lines of the first thread layer according to any one of embodiments (3)-(8) are not bonded to one another and the thread lines of the second thread layer according to any one of embodiments (3)-(8) are not bonded to one another before impregnating at least the portions of the first and second continuous threads with the flowable liquid polymer, respectively.

In a tenth embodiment (10), impregnating at least the portions of the first and second continuous threads with the flowable liquid polymer according to any one of embodiments (3)-(9) comprises soaking the first and second thread layers in the flowable liquid polymer.

In an eleventh embodiment (11), impregnating at least the portion of the first continuous thread with the flowable liquid polymer according to any one of embodiments (1)-(10) comprises applying the flowable liquid polymer to at least the portion of the first continuous thread while winding the first continuous thread around the plurality of projections.

In a twelfth embodiment (12), impregnating at least the portion of the first continuous thread with the flowable liquid polymer according to any one of embodiments (1)-(11) comprises applying the flowable liquid polymer to at least the portion of the first continuous thread before winding the first continuous thread around the plurality of projections.

In a thirteenth embodiment (13), impregnating at least the portion of the first continuous thread with the flowable liquid polymer according to any one of embodiments (1)-(12) comprises applying the flowable liquid polymer to thread lines of the first thread layer after winding the first continuous thread around the plurality of projections.

In a fourteenth embodiment (14), impregnating at least the portion of the first continuous thread with the flowable liquid polymer according to any one of embodiments (1)-(13) completely embeds individual thread lines of the first thread layer in the flowable liquid polymer.

In a fifteenth embodiment (15), the flowable liquid polymer according to any one of embodiments (1)-(14) comprises an epoxy resin.

A sixteenth embodiment (16) of the present application is directed to an article of apparel, comprising: a first thread layer comprising a first perimeter edge and a plurality of first thread lines extending continuously from a first side of the first perimeter edge to a second side of the first perimeter edge; a second thread layer comprising a second perimeter edge and a plurality of second thread lines extending continuously from a first side of the second perimeter edge to a second side of the second perimeter edge; a third layer between the first and second thread layers, the third layer comprising a different material than the first and second thread layers; and a polymer matrix bonding the first thread lines to one another, the second thread lines to one another, the first thread layer to the third layer, and the second thread layer to the third layer.

In a seventeenth embodiment (17), the polymer matrix according to the sixteenth embodiment (16) comprises an epoxy.

In an eighteenth embodiment (18), the different material according to any one of embodiments (16)-(17) is a foam material.

In a nineteenth embodiment (19), the first and second thread lines according to any one of embodiments (16)-(18) are non-woven and non-knitted thread lines, and the first and second thread lines according to any one of embodiments (16)-(18) are non-embroidered thread lines.

In a twentieth embodiment (20), the article of apparel according to any one of embodiments (16)-(19) comprises a shoe.

In a twenty-first embodiment (21), the first thread layer, the second thread layer, the third layer, and the polymer matrix according to the twentieth embodiment (20) form one or more of at least a portion of a shoe upper and at least a portion of a shoe sole.

A twenty-second embodiment (22) of the present application is directed to a method of making an article of apparel, the method comprising: winding a continuous thread around a plurality of projections to form a thread layer; bonding thread lines of the thread layer to one another; after bonding the thread lines of the thread layer to one another, bonding the thread layer to a rigid plate such that one or more thread lines of the thread layer extend across an opening formed in the rigid plate.

In a twenty-third embodiment (23), bonding the thread lines of the thread layer to one another according to the twenty-second embodiment (22) comprises applying a polymeric sheet to the thread layer; and heating the polymeric sheet to at least partially melt the polymeric sheet.

In a twenty-fourth embodiment (24), the polymeric sheet according to the twenty-third embodiment (23) comprises thermoplastic polyurethane.

A twenty-fifth embodiment (25) of the present application is directed to an article of apparel, comprising: a rigid plate comprising an opening; a thread layer comprising a perimeter edge and a plurality of thread lines bonded to each other and each extending continuously from a first side of the perimeter edge to a second side of the perimeter edge, the thread layer bonded to the rigid plate such that one or more thread lines of the thread layer extend across the opening.

In a twenty-sixth embodiment (26), the rigid plate according to the twenty-fifth embodiment (25) is a sole plate for a shoe.

In a twenty-seventh embodiment (27), the rigid plate according to any one of embodiments (25)-(26) comprises a plurality of openings and one or more thread lines of the thread layer extend across the plurality of openings.

In a twenty-eighth embodiment (28), the one or more thread lines extending across the opening according to any one of embodiments (25)-(27) are separated by empty space within the opening.

In a twenty-ninth embodiment (29), the article of apparel according to any one of embodiments (25)-(28) comprises a polymeric sheet bonded to the thread lines.

In a thirtieth embodiment (30), the polymeric sheet according to the twenty-ninth embodiment (29) comprises thermoplastic polyurethane.

In a thirty-first embodiment (31), the plurality of thread lines according to any one of embodiments (25)-(30) are non-woven and non-knitted thread lines, and the plurality of thread lines according to any one of embodiments (25)-(30) are non-embroidered thread lines.

A thirty-second embodiment (32) of the present application is directed to a method of making an article of apparel, the method comprising: winding a first continuous thread around a plurality of projections according to a first winding pattern to form a first thread layer comprising thread lines, the first continuous thread comprising a first material; winding a second continuous thread around the plurality of projections according to a second winding pattern to form a second thread layer, the second continuous thread comprising a second material having a melting point lower than that of the first material, the second winding pattern matching the first winding pattern; and applying heat to the second continuous thread to at least partially melt the second continuous thread to bond the thread lines of the first thread layer to one another by embedding the thread lines of the first thread layer within the second material.

In a thirty-third embodiment (33), the first winding pattern according to the thirty-second embodiment (32) comprises a first order of projections around which the first continuous thread is wound, the second winding pattern according to the thirty-second embodiment (32) comprises a second order of projections around which the second continuous thread is wound, and the second order is either the same as the first order or an inverse of the first order.

In a thirty-fourth embodiment (34), the heat according to any one of embodiments (32)-(33) is applied to the second continuous thread while the first thread layer and the second thread layer are attached to the plurality of projections.

### BRIEF DESCRIPTION OF THE DRAWINGS/FIGURES

FIG. 1A shows an article of apparel according to some embodiments.

FIG. 1B shows a portion of the article of apparel of FIG. 1A according to some embodiments.

FIGS. 2A-2C show thread layers according to some embodiments.

FIG. 3 shows a thread pattern according to some embodiments.

FIG. 4 shows an apparatus for producing thread layers or thread patterns according to some embodiments.

FIG. 5 is an exemplary flowchart of a method according to some embodiments.

FIG. 6 shows a layered structure according to some embodiments.

FIG. 7 shows the layered structure of FIG. 6 according to some embodiments.

FIG. 8 shows the layered structure of FIGS. 6-7, a mold, and a vacuum bag according to some embodiments.

FIG. 9 shows a subset of the layered structure of FIGS. 6-7 according to some embodiments.

FIG. 10 is an exemplary flowchart of a method according to some embodiments.

FIG. 11 shows a mold according to some embodiments.

FIG. 12 shows one or more thread layers coupled to an additional component according to some embodiments.

FIG. 13 shows a thread layer and a bonding sheet according to some embodiments.

FIG. 14 shows a heat press according to some embodiments.

FIG. 15 shows a three-dimensional object for winding a continuous thread according to some embodiments.

FIG. 16 is an exemplary flowchart of a method according to some embodiments.

FIG. 17 shows a low-melting point continuous thread according to some embodiments.

FIG. 18 is an exemplary flowchart of a method according to some embodiments.

FIG. 19 shows a schematic block diagram of an exemplary computer system with which embodiments can be implemented.

### DETAILED DESCRIPTION

The present invention(s) will now be described in detail with reference to embodiments thereof as illustrated in the accompanying drawings. References to “some embodiments”, “one embodiment”, “an embodiment”, “an exemplary embodiment”, etc., indicate that the embodiment described can comprise a particular feature, structure, or characteristic, but every embodiment may not necessarily comprise the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list can also be present.

As used herein, unless specified otherwise, references to “first,” “second,” “third,” “fourth,” etc. are not intended to denote order, or that an earlier-numbered feature is required for a later-numbered feature. Also, unless specified otherwise, the use of “first,” “second,” “third,” “fourth,” etc. does not necessarily mean that the “first,” “second,” “third,” “fourth,” etc. features have different properties or values.

An article of apparel has many purposes. Among other things, apparel can provide a unique aesthetic look, provide warming or cooling characteristics, provide support for portions of an individual's body, and provide other performance characteristics, such as air permeability, moisture wicking properties, compression properties. Each of these purposes, alone or in combination, provides for comfortable apparel suitable for use in a variety of scenarios (for example, exercise and every day activities). The features of an article of apparel (for example, the materials and components used to make apparel, and the way these materials/components are made) can be altered to produce desired characteristics, for example, durability, stiffness, weight, tackiness, texture, haptics, tackiness, and/or air permeability.

An article of apparel, or a portion thereof (for example, an upper or sole portion of a shoe), can be configured to provide various degrees of durability, support, weight, breathability, etc. But the cost of manufacturing the article of apparel can also be a consideration. Apparel, or a portion thereof, that can be manufactured at a relatively low cost can be desirable for manufacturers and consumers. Apparel that can be manufactured using a relatively small amount of resources (for example, energy and labor), materials, and time reduces manufacturing costs and can also reduce the environmental impact of manufacturing.

Further, a manufacturing process that facilitates the manufacture of customized apparel without increasing the complexity of the manufacturing process can be desirable. Customizing an article of apparel, or a portion thereof (for example, an upper or sole portion of a shoe), for a particular individual or a group of individuals having similar foot anatomies (for example, foot size and shape) can provide proper support and increased comfort for an individual. Also, it can allow an individual to order/buy articles of apparel customized to his or her needs. Moreover, it can allow the individual to order/buy new and/or replacement articles of apparel customized to his or her needs when desired.

The articles of apparel described herein can be made by, or can comprise a layer made by, winding one or more continuous threads around anchor points to create a desired thread layer or thread pattern. Winding the continuous thread(s) around the anchor points comprises wrapping a continuous thread around a first anchor point, extending that continuous thread to a second anchor point, wrapping that continuous thread around the second anchor point, and so on. The number and position of the anchor points can be utilized to control characteristics of the thread layer or thread pattern, and therefore characteristics of the apparel. Also, the number of times a continuous thread is wound from anchor point to anchor point can be utilized to control characteristics of the thread layer or thread pattern, and therefore characteristics of the apparel.

Continuous thread(s) of a thread layer or thread pattern can be bonded within the thread layer or thread pattern. The bonding of continuous thread(s) of a thread layer or thread pattern can consolidate the layer or pattern and set thread lines within the layer or pattern. In some embodiments, bonding continuous thread(s) of a thread layer or thread pattern can be utilized to control characteristics of the layer or pattern. In some embodiments, a continuous thread can be bonded to itself within a thread layer or thread pattern. In some embodiments, a continuous thread can be bonded to itself at points of overlap between different thread lines of the continuous thread (i.e., at thread line intersection points). In some embodiments, different continuous threads of a thread layer or pattern can be bonded together. In some embodiments, different continuous threads can be bonded to each other at points of overlap between the different continuous threads (i.e., at intersection points between the different continuous threads). The bonding of continuous thread(s) can set the continuous thread(s) in tension because the thread(s) can be wound around anchor points in tension. The bonding of thread(s) in tension allows a thread layer or thread pattern to contract once removed from anchor points used to wind the thread layer or thread pattern, which can be utilized to control characteristics of the thread layer or thread pattern.

As used herein, two components (for example, two threads or a thread and another material) described as “bonded to” each other means the first component and second component are bonded to each other, either by direct contact and/or bonding between the two components or via an adhesive or bonding layer. Two components (for example, two threads or a thread and another material) described as “directly bonded to” each other means the two components are directly bonded to each other via a material of the first component, a material of the second component, or both. For example, where heat and/or pressure is utilized to directly bond the polymeric material of a first thread to a second thread, the first thread is directly bonded to the second thread via the polymeric material of the first thread. In such embodiments, the polymeric material can be thermally fused to the second thread.

In some embodiments, a plurality of different continuous threads can be wound around anchor points to form a plurality of thread layers for a thread pattern. In some embodiments, different continuous threads can be wound in the same configuration (i.e., around the same anchor points and along the same paths). In some embodiments, different continuous threads can be wound in different configurations (i.e., around one or more different anchor points and/or along different paths between one or more anchor points). In some embodiments, different continuous threads can define different wound layers for an article of apparel, or portion thereof. In such embodiments, the different layers can provide different characteristics to a thread pattern, and therefore provide different characteristics on the article of apparel.

Continuous thread(s) can be wound around anchor points (for example, projections as discussed herein) in various configurations to provide varying degrees of characteristics for an article of apparel. The number of anchor points, the position of the anchor points, the way continuous threads are wound around the anchor points, and/or of the material of threads wound around the anchor points can be utilized to produce apparel having desired characteristics, such as strength, stiffness, air permeability, comfort, abrasion resistance, fit, texture, haptics, tackiness, and durability. Characteristics of an article of apparel can be varied by changing the arrangement of anchor points and/or the way continuous thread(s) are wound around the anchor points. Characteristics can also be varied by altering the material of continuous thread(s).

In some embodiments, when the article of apparel is a shoe, a plurality of thread layers and/or thread patterns can be bonded together in a process for forming an upper material that surrounds all or a portion of a wearer's foot during use. In some embodiments, the upper material that surrounds all or a portion of a wearer's foot during use can comprise a portion that extends across and wraps around at least a portion of the bottom of a wearer's foot. In some embodiments, the upper material need not comprise such a portion. For example, the upper material can be configured for attachment to the sole of a shoe at the sides of a wearer's foot and not beneath. In some embodiments, bonding a plurality of thread layers and/or thread patterns together can create an upper material having a void configured to receive all or a portion of a wearer's foot.

In some embodiments, methods for bonding wound continuous thread(s), for example, at intersection points between thread lines formed by the continuous thread(s), can comprise impregnating at least a portion of the continuous thread(s) with a flowable liquid polymer either before, during, or after winding of the continuous thread(s) around anchor points. The flowable liquid polymer can be dried to bond thread lines formed by the continuous thread(s) to one another and/or to other components, for example, components of an article of apparel.

In some embodiments, at least a portion of a wound thread layer can be impregnated with a flowable liquid polymer and combined with other thread layer(s) and/or components to form a layered structure. The flowable liquid polymer can serve to form a bonding matrix that secures the thread layer to the other thread layer(s) and/or components. In some embodiments, the layered structure can include multiple thread layers or thread patterns and can be formed to the shape of at least a portion of an article of apparel.

In some embodiments, a component to which one or more thread layers are bonded can comprise one or more openings. In some embodiments, the component can be a rigid plate. Thread lines of the one or more thread layers can extend across the one or more openings.

In some embodiments, thread lines of a thread layer can be bonded together by winding a first and second continuous thread according to the same winding pattern, such that the second continuous thread overlays at least a portion of the first continuous thread. The second continuous thread can comprise a material having a lower melting point than a material of the first continuous thread. When heat is applied to the second continuous thread, the second continuous thread can at least partially melt, bonding thread lines of the thread layer to one another by embedding the thread lines of the thread layer within the material of the second continuous thread.

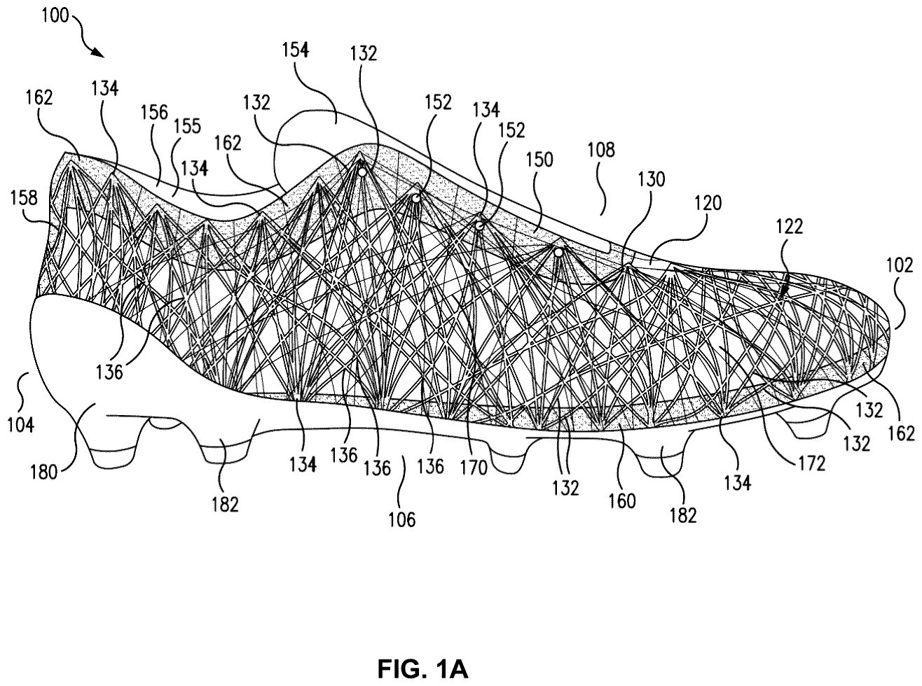

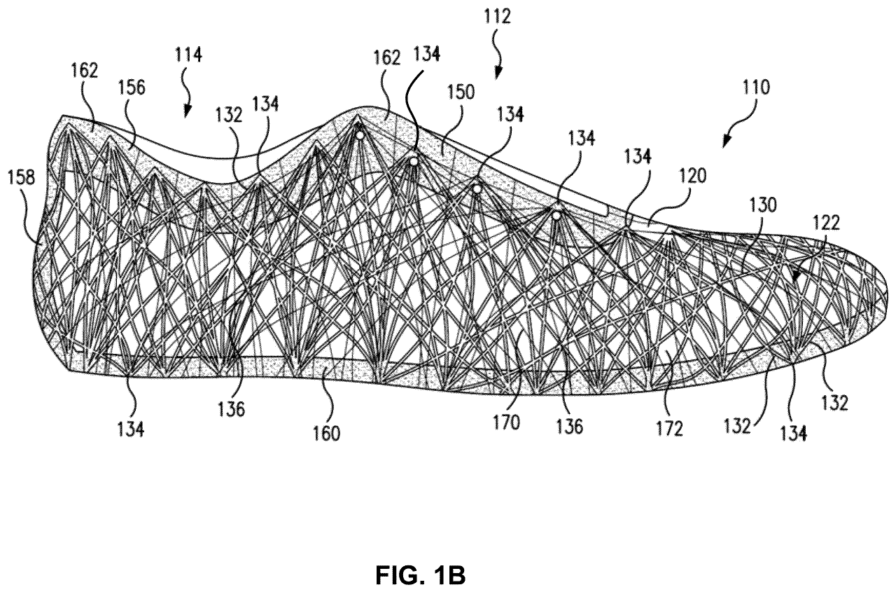

FIGS. 1A and 1B show an article of apparel 100 according to some embodiments. While article of apparel 100 is shown as a shoe, article of apparel 100 can be any article of apparel comprising a wound component comprising one or more thread layers. As used herein, “apparel” can be any item that is worn or adorns an individual, including both clothing and accessories. Clothing can comprise, but is not limited to pants, shorts, leggings, socks, a shoe (which can refer any type of footwear, including a sneaker, a cleat, a boot, a slipper, a flip-flop, a sandal, etc.), a shoe upper, a shoe sole, a jacket, a coat, a hat, a sleeve, a sweater, a shirt, a bra, a jersey, a bootie, a glove, an arm sleeve, a knee sleeve, an elbow sleeve, a wrist sleeve, an ankle sleeve. Accessories can comprise, but are not limited to a headband, a waistband, a belt, a wristband, a bracelet, a watch band, a shoulder wrap, a tape, a shin guard, a hat, a tie, a scarf, a purse, a handbag, a wallet, a knapsack, or a backpack. In particular embodiments, any article of apparel described herein (for example, article of appeal 100) can be an article of footwear, an upper for an article of footwear, or a sole for an article of footwear.

In some embodiments, article of apparel 100 can comprise an upper 120 coupled to a sole 180. Article of apparel 100 and upper 120 can comprise a forefoot end 102, a heel end 104, a medial side 106, and a lateral side 108 opposite medial side 106. As illustrated in FIG. 1B, upper 120 can comprise a forefoot portion 110, a midfoot portion 112, and a heel portion 114. Portions 110, 112, and 114 are not intended to demarcate precise areas of upper 120. Rather, portions 110, 112, and 114 are intended to represent general areas of upper 120 that provide a frame of reference. Although portions 110, 112, and 114 are illustrated in connection with upper 120 in FIG. 1B, references to portions 110, 112, and 114 also can apply specifically to article of apparel 100 or sole 180, or individual components of article of apparel 100 or sole 180.

Upper 120 can be formed of one or more components that are stitched, bonded, or otherwise joined together to form a structure for receiving and securing a foot relative to sole 180. And upper 120 can comprise at least a portion defined by one or more thread layer(s) 122. Thread layer(s) 122 can be made by winding one or more continuous threads as discussed herein. Thread layer(s) 122 are not knitted, woven, or embroidered layer(s). Thread layer(s) 122 can be referred to as a thread network of adjacent and overlapping thread lines. Thread layer(s) 122 can comprise any thread layer described herein, for example thread layers 200, 220, 240, 710, 720, 1110, 1510, or a thread layer of thread pattern 1700.

In some embodiments, thread layer(s) 122 can comprise a network of individual thread lines that form a substantially continuous material with minimal void space between thread lines. As used herein, “void space” means an opening extending through a thread layer or thread pattern between thread lines of the thread layer or thread pattern. In some embodiments, the substantially continuous material can have a ratio (V:T) of void space (V) to thread material (T) of at least 1:1 measured across all or a portion of an outer surface of a thread layer or thread pattern. In some embodiments, the ratio of void space to thread material can be at least 1:1, 1:2, 1:2.5, 1:3, 1:4, 1:5, 1:6, 1:7, 1:8, 1:9, 1:10, 1:20, 1:50, or 1:100. In some embodiments, a thread layer or thread pattern can comprise a network of thread lines that form a continuous material with no void space between thread lines. A ratio of void space to thread material can be measured for a thread layer or thread pattern before or after bonding of thread lines. In some embodiments, bonding of thread lines can serve to reduce the amount of void space of a thread layer or thread pattern. For example, thermally bonding thread lines via a polymer material of the thread lines can reduce the amount of void space by filling in void space with thermally melted polymer material. In some embodiments, melted polymer material(s) of a thread layer or thread pattern can fill void spaces between thread lines to form a continuous material without void space between thread lines.

In embodiments in which article of apparel 100 comprises a shoe, thread layer(s) 122 can wrap around all or a portion of the sides, the top, and/or the heel of a wearer's foot. In some embodiments, thread layer(s) 122 can wrap around at least a portion of the bottom surface (i.e., the sole) of a wearer's foot when worn. For example, an upper with thread layer(s) 122 can wrap around the bottom surface of a wearer's foot when worn. As another example, thread layer(s) 122 can wrap around the bottom surface of a wearer's foot by wrapping around a sole for an article of footwear. As another example, thread layer(s) 122 can wrap around the bottom surface of a wearer's foot by extending through a sole for an article of footwear.

Upper 120 can extend along the lateral side of the foot, along the medial side of the foot, over the foot, around a heel of the foot, and/or under the foot when worn. Upper 120 can define a void 155, which can be a generally hollow area having the general shape of a foot and can be configured to receive the foot. An opening of void 155 can be defined in whole or in part by a collar 156 located in at least heel portion 114 of upper 120.

In addition, upper 120 can comprise a throat area 150 extending from collar 156 towards forefoot portion 110 of upper 120. Throat area 150 can extend over a dorsal area of a wearer's foot that corresponds generally to the location of a wearer's cuneiform and metatarsal bones. In some embodiments, throat area 150 can define an opening for a tongue 154 that extends between lateral and medial perimeter sides of throat area 150 and moveably opens and closes a portion of void 155 to enhance the adjustability of article of apparel 100.

In some embodiments, upper 120 can also comprise one or more eyelets 152 formed in a perimeter portion of throat area 150 for securing and tensioning a shoelace. More particularly, the shoelace can allow a wearer to tighten or loosen upper 120 around his or her foot. In some embodiments, upper 120 can comprise a heel counter 158. Heel counter 158 can provides cushioning, support, and/or protection for a wearer's heel and/or Achilles tendon.

With reference to FIG. 1A, upper 120 can be coupled to sole 180 at a biteline 160 (i.e., a sole connection area). Together, biteline 160, collar 156, heel counter 158, and a perimeter portion of throat area 150 can define a perimeter portion 162 of upper 120. Perimeter portion 162 can comprise an outer edge defined by biteline 160 and an inner edge defined by collar 156 and a perimeter of throat area 150. Perimeter portion 162 can define a frame having a shape corresponding to at least a portion of a perimeter shape of upper 120. Portions of upper 120 within perimeter portion 162 can comprise the quarter panels, vamp portion, and toe box portion of upper 120. Thread layer(s) 122 can define all or a portion of perimeter portion 162 and/or any portion of upper 120 within perimeter portion 162 of upper.

In some embodiments, upper 120 can comprise a fabric layer 172 disposed on the outer surface and/or the inner surface of thread layer(s) 122. As used herein, the term “outer surface” or “outer side” refers to the surface of a component that faces away from the foot when worn by a wearer. And “inner surface” or “inner side” refers to the surface of a component that faces toward the foot when worn by a wearer.

In some embodiments, fabric layer 172 can be a woven, non-woven, or knitted polymeric layer. In some embodiments, fabric layer 172 can be a woven, non-woven, or layer composed of thermoplastic polyurethane (TPU), polyester, polyamide, polyethylene (PE), PE foam, polyurethane (PU) foam, and co-polymers or polymer blends comprising one or more these polymers. In some embodiments, fabric layer 172 can be a bioengineered woven, knitted or layered synthetic spider silk, woven, knitted or layered plant based materials, or woven, knit or layered recycled and/or extruded plastics. In some embodiments, fabric layer 172 can be film or sheet of a polymeric material, such as thermoplastic polyurethane (TPU), polyester, polyamide, polyethylene (PE), PE foam, polyurethane (PU) foam, and co-polymers or polymer blends comprising one or more these polymers. In some embodiments, fabric layer 172 can be a woven, non-woven, or knitted layer for providing cushion and/or thermal insulation for article of apparel 100. In some embodiments, fabric layer 172 can be a sock bootie. In some embodiments, fabric layer 172 can be a discontinuous layer formed of individual spaced-apart fabric elements.

In some embodiments, sole 180 can comprise traction elements, such as cleats 182 or tread. In some embodiments, sole 180 can comprise a midsole. In some embodiments, sole 180 can comprise an outsole coupled to a midsole. Sole 180 and portions thereof can comprise material(s) for providing desired cushioning, ride, and stability. Suitable materials for sole 180 include, but are not limited to, a foam, a rubber, ethyl vinyl acetate (EVA), expanded thermoplastic polyurethane (eTPU), expandable polyether block amide (ePEBA), thermoplastic rubber (TPR) and a thermoplastic polyurethane (TPU). In some embodiments, the foam can comprise, for example, an EVA-based foam or a PU-based foam and the foam can be an open-cell foam or a closed-cell foam. In some embodiments, the midsole and/or outsole can comprise elastomers, thermoplastic elastomers (TPE), foam-like plastics, and gel-like plastics.

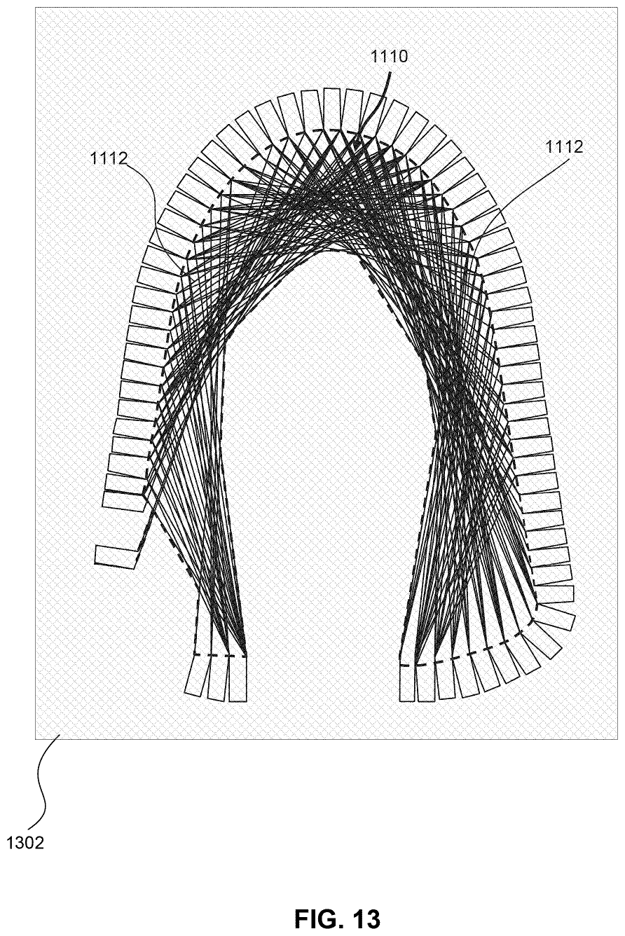

In some embodiments, sole 180 can comprise a wound component (for example, thread layer(s) 1110), as shown in FIG. 13. In such embodiments, the wound component can influence the cushioning, stability, and ride characteristics of sole 180. In particular, features of the wound component (for example, thread tension, thickness, density, etc.) can determine in part the cushioning, stability, and/or ride characteristics of sole 180. In some embodiments, sole 180 can comprise a plate (for example, plate 1210) in which one or more openings have been formed, and the wound component can extend across the openings. In some embodiments, the one or more openings can increase the flexibility of sole 180.

As shown in FIGS. 1A and 1B, upper 120 can comprise one or more thread layer(s) 122. All or a portion of upper 120 can comprise thread layer(s) 122. In some embodiments, thread layer(s) 122 can be a single thread layer defining at least a portion of upper 120. In some embodiments, thread layer(s) 122 can comprise a plurality of thread layers coupled together to define at least a portion of upper 120.

In some embodiments, thread layer(s) 122 can comprise a plurality of anchor points 134 and a continuous thread 130 fixed at a plurality of anchor points 134. In some embodiments, anchor points 134 can be disposed along a perimeter of upper 120 (for example, in perimeter portion 162). Such anchor points 134 can be referred to as “peripheral anchor points.”

As used herein, “thread” means a material having a length that is substantially larger than its width. A “thread” can be a filament, a fiber, a yarn, a cable, a cord, a fiber tow, a tape, a ribbon, a monofilament, a braid, a string, a plied thread, and other forms of materials which can be spooled and laid down in a thread layer or thread pattern as described herein.

As used herein, “anchor point” means a location to which a thread or group of thread lines is fixedly attached. A thread or thread line can be wrapped, wound, bonded, or otherwise attached at an anchor point. In some embodiments, an anchor point can be a location on an article of apparel. For example, an anchor point can be a hole or opening left behind by a structure (for example, pin, projection, or nub) used to wind continuous thread(s) of a thread layer and/or thread pattern. In some embodiments, a thread layer or thread pattern for an article of apparel does not comprise any anchor point locations because all the anchor point locations present during winding of the thread layer or thread pattern have been removed (for example, cut off). An anchor point can be a structure (for example, pin, projection, or nub) used to wind continuous thread(s) of a thread layer and/or thread pattern. And the anchor point structure can or may not form a portion of a thread layer or thread pattern for an article of apparel.

A continuous thread wrapped or wound around an anchor point need not be wrapped or wound completely (i.e., 360 degrees) around the anchor point. A continuous thread wrapped or wound around an anchor point can be wrapped or wound around only a portion of the anchor point. For example, a continuous thread wrapped or wound around an anchor point can be wrapped or wound around 25% (90 degrees) of an anchor point's perimeter, 50% (180 degrees) of an anchor point's perimeter, 75% (270 degrees) of an anchor point's perimeter, or 100% (360 degrees) of an anchor point's perimeter. In some embodiments, a continuous thread can be wrapped or wound around an anchor point's perimeter more than once before being threaded to the next anchor point. For example, a continuous thread can be wrapped or wound around an anchor point's perimeter one and a half times (540 degrees) or twice (720 degrees) before being threaded to the next anchor point.

Continuous thread 130 can be wrapped around a plurality of anchor points 134 and can comprise a plurality of thread lines 132. Each thread line 132 can extend between two respective anchor points 134. In some embodiments, thread lines 132 can be bonded at points where two or more thread lines 132 overlap in a thread layer (i.e., intersection points 136). In some embodiments, upper 120, and thread layer(s) 122, can comprise more than one continuous thread. For example, as shown in FIGS. 1A and 1B, thread layer(s) 122 can comprise a second continuous thread 170. Second continuous thread 170 can have the same or different characteristics as first continuous thread 130. And second continuous thread 170 can be incorporated into thread layer(s) 122 in the same manner as first continuous thread 130.

While FIGS. 1A and 1B show two thread layer(s) 122 comprising two continuous threads (130 and 170), article of apparel 100 can comprise any number of thread layer(s) 122 with any suitable number of continuous threads, such as for example, one, three or more, four or more, five or more, six or more, seven or more, eight or more, nine or more, ten or more, fifteen or more, or twenty or more thread layers. Additional continuous threads can be the same as or different from continuous threads 130 and 170. And additional continuous threads can be incorporated into thread layer(s) 122 in the same manner as continuous threads 130 and 170. Additional continuous threads can be wound around and extended between anchor points 134 in the same fashion as continuous threads 130 and 170.

In embodiments comprising a plurality of continuous threads, each wound continuous thread can define a thread layer of thread layer(s) 122. For example, a thread layer defined by wound continuous thread 130 can define a first thread layer of thread layer(s) 122 and a thread layer defined by wound continuous thread 170 can define a second thread layer of thread layer(s) 122. And different thread layers of a thread pattern can be disposed over each other in areas of overlap between the two thread layers. For example, a first thread layer defined by continuous thread 130 can be disposed over a second thread layer defined by continuous thread 170, or vice versa, in areas of overlap between the two thread layers. Different thread layers defined by different continuous wound threads can provide different characteristics to different areas of upper 120.

In some embodiments, thread layer(s) 122 can define at least 10%, at least 20%, at least 30%, at least 40%, at least 50%, at least 60%, at least 70%, at least 80%, or at least 90% of a component of upper 120. In some embodiments, thread layer(s) 122 can occupy at least 10%, at least 20%, at least 30%, at least 40%, at least 50%, at least 60%, at least 70%, at least 80%, or at least 90% of the outer surface area of upper 120. In some embodiments, thread layer(s) 122 can be visibly exposed on the outer surface of upper 120. In some embodiments, no lamination layer or supporting textile layer is disposed over thread layer(s) 122 on the outer surface of upper 120. In some embodiments, thread layer(s) 122 can be devoid of a lamination layer.

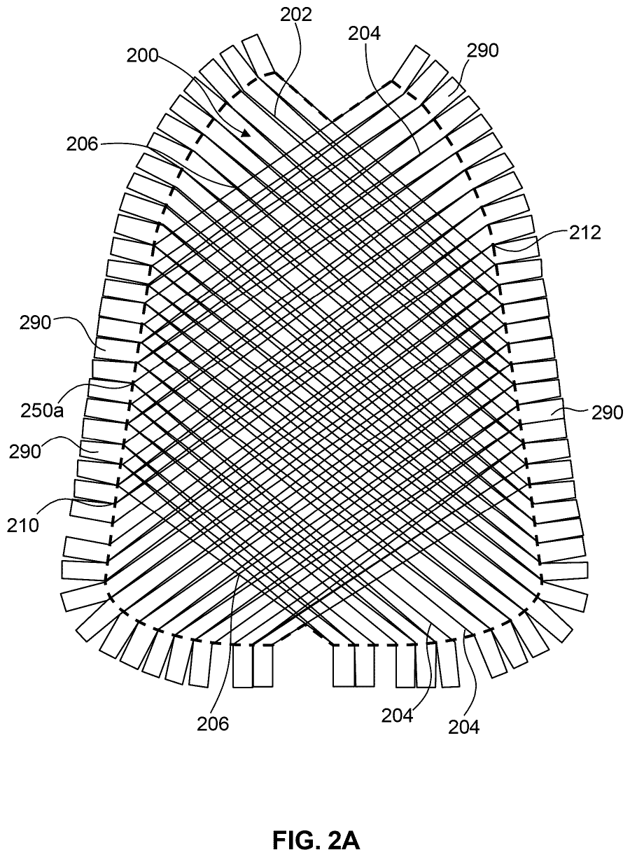

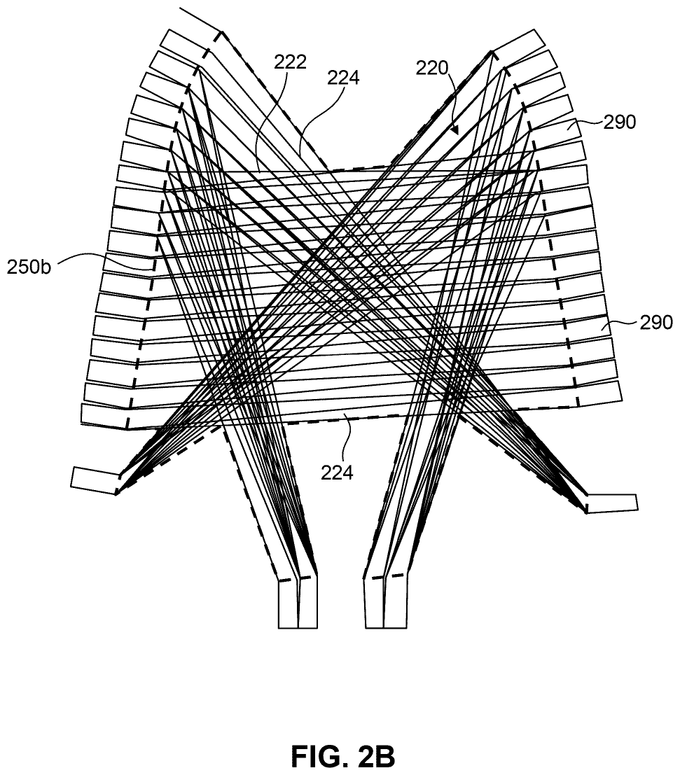

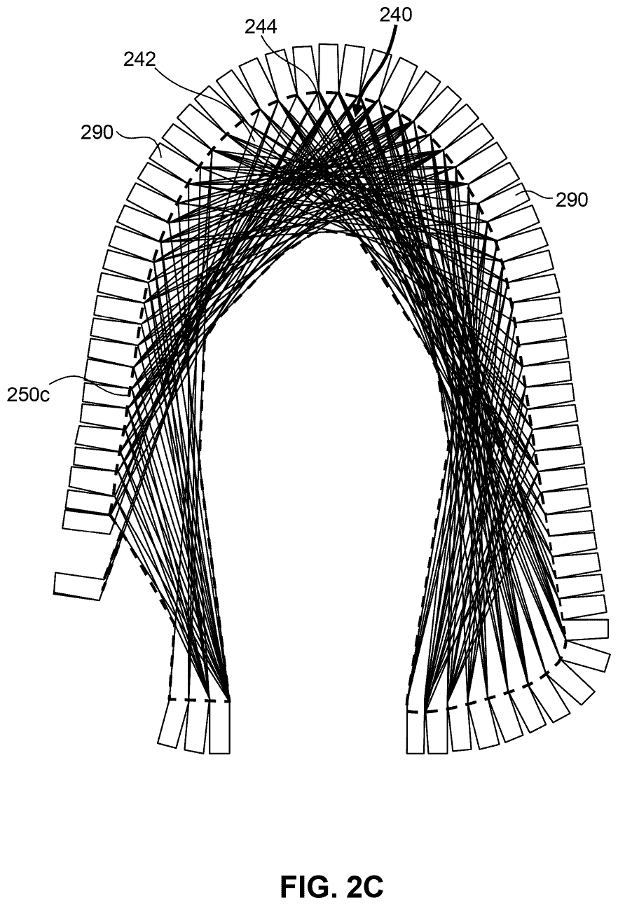

FIGS. 2A-2C show various thread layers which can be comprised by, for example, article of apparel 100. Thread layers as described herein (for example, thread layers 200, 220, and 240) can each comprise a thread border 250 defined by the space in which thread lines of the thread layer are located. The thread border 250 for a thread layer is the space in which thread lines of the thread layer are located after the thread layer is removed (for example, cut) from anchor points used to wind the thread layer. A plurality of thread lines within a thread layer or thread pattern can comprise a first end located at a first side of the thread border 250 and a second end located at a second side of the thread border 250. For example, thread lines 204 of thread layer 200 can comprise a first end 210 located at a first side of thread border 250 and a second end 212 located at a second side of thread border 250.

FIGS. 2A-2C illustrate thread borders 250a-c for thread layers 200, 220, and 240. For a thread pattern comprising a plurality of thread layers, the thread pattern can comprise a thread pattern border 250 defined by the space occupied by the combination of the individual thread layers. For example, a thread pattern comprising thread layers 200, 220, and 240 comprises a thread pattern border defined by the space occupied by the combination of border 250a and border 250c. Border 250b is wholly contained within border 250a. A thread border 250 can define the perimeter edge of a thread layer. Similarly, the combination of two or more thread borders 250 can define the perimeter edge of a thread pattern.

As used herein, sides of a perimeter edge or a border refer to top, bottom, right, and left sides of a shape defined by the edge or border. The top, bottom, right, and left sides of the shape are located to the top, bottom, right, and left of a geometrical center of the shape. So, a perimeter edge or border will have a top side defined by the portion of the edge located above the geometrical center, a bottom side defined by the portion of the edge located below the geometrical center, a right side defined by the portion of the edge or border located to the right of the geometrical center, and a left side defined by the portion of the edge or border located to the left of the geometrical center. The top and bottom sides do not overlap. Similarly, the left and right sides do not overlap. The top and left sides overlap at the portion of the edge or border located to the top-left of the geometrical center. The top and right sides overlap at the portion of the edge or border located to the top-right of the geometrical center. The bottom and left sides overlap at the portion of the edge or border located to the bottom-left of the geometrical center. The bottom and right sides overlap at the portion of the edge or border located to the bottom-right of the geometrical center. For purposes of determining the shape defined by the perimeter edge or border, the material having the edge or border is laid in a flat configuration with no portion of the material overlapping itself.

As used herein, a first side of a perimeter edge or border can be the top, bottom, right, or left side of the edge or border and a second side of the perimeter edge can be the top, bottom, right, or left side of the edge or border, provided that the first and second sides are not the same side. Similarly, a third side of a perimeter edge or border can be the top, bottom, right, or left side of the edge or border and a fourth side of the edge or border can be the top, bottom, right, or left side of the edge or border, provided that the third and fourth sides are not the same, and are not the same as the first or second sides.

In some embodiments, one or more thread layers (for example, thread layers 200, 220, and 240) can comprise a thread defining (i) a plurality of thread lines each extending from a first side of a thread border to a second side of the thread border and crossing over each other at points of overlap between two or more of the thread lines, and (ii) a plurality of thread lines each extending from a third side of the thread border to a fourth side of the thread border and crossing over each other at points of overlap between two or more of the thread lines. The thread lines extending from the first side to the second side can extend continuously from the first side to the second side, and the thread lines extending from the third side to the fourth side can extend continuously from the third side to the fourth side.

Thread layer 200 comprises a continuous thread 202 wound around anchor points 290. Thread layer 220 comprises a continuous thread 222 wound around anchor points 290. Thread layer 240 comprises a continuous thread 242 wound around anchor points 290. In some embodiments, anchor points 290 can be different sets of anchor points around which different thread layers are wound. In some embodiments, a plurality of thread layers can wound around the same set of anchor points 290. In such embodiments, separate thread layers can be wound over each other, with one thread layer disposed over one or more other thread layers.

Continuous thread 202 can be wrapped around a plurality of anchor points 290 and comprises a plurality of thread lines 204. Each thread line 204 extends between two respective anchor points 290.

Continuous thread 202 can be wrapped around a plurality of anchor points 290 in tension such that individual thread lines 204 are in tension when wrapped around anchor points 290. In some embodiments, the tension at which thread lines 204 are wound can range from 0 centinewtons (cN) to 25 cN, including subranges. For example, in some embodiments, the tension at which thread lines 204 are wound can range from 0.01 cN to 25 cN, from 0.1 cN to 25 cN, from 1 cN to 25 cN, from 5 cN to 25 cN, from 10 cN to 25 cN, or from 15 cN to 25 cN. In some embodiments, the tension at which thread lines 204 are wound can range from 2 cN to 10 cN. In some embodiments, the tension at which thread lines 204 are wound can range from 2 cN to 6 cN. In such embodiments, the tension can create the compressive force applied along thread lines as described herein. In some embodiments, the compressive force can range from 0 cN to 25 cN, including subranges. For example, in some embodiments, the compressive force can range from 0.01 cN to 25 cN, from 0.1 cN to 25 cN, from 1 cN to 25 cN, from 5 cN to 25 cN, from 10 cN to 25 cN, or from 15 cN to 25 cN. In some embodiments, the compressive force can range from 2 cN to 10 cN. In some embodiments, the compressive force can range from 2 cN to 6 cN.

The number of thread lines 204 for thread layer 200 fixed at an anchor point 290 is defined by the “thread line communication number” of an anchor point 290. As used herein, “thread line communication number” means the number of thread lines extending from an anchor point to different anchor points. Two thread lines extending between the same two anchor points (i.e., overlaying thread lines) only counts as “1” for purposes of calculating a thread line communication number for the anchor points. For example, a thread line communication number of five means that an anchor point has five thread lines extending from it with each of the five thread lines leading to another, different anchor point. As another example, a thread line communication number of six means that an anchor point has six thread lines extending from it with each of the six thread lines leading to another, different anchor point.

Similarly, the number of thread lines fixed at an anchor point 290 for a thread pattern comprising a plurality of thread layers is defined by the “thread line communication number” of an anchor point 290 for the thread pattern. For a thread pattern, the “thread line communication number” of an anchor point 290 is the total number of thread lines, for the plurality of layers, extending from an anchor point to different anchor points.

Anchor points 290 can have a thread line communication number of “X” or more for a thread layer or a thread pattern. In some embodiments, two or more respective anchor points 290 can have a thread line communication number of “X” or more. In some embodiments, all the anchor points 290 for a thread layer or a thread pattern can have a thread line communication number of “X” or more. “X” can be, for example, 2, 3, 4, 5, 6, 7, 8, 9, 10, 15, 20, 25, 30, 35, 40, 45, or 50, within a range having any two of these values as end points. For example, in some embodiments “X” can be in a range of 2 to 50, 3 to 50, 4 to 50, 5 to 50, 6 to 50, 7 to 50, 8 to 50, 9 to 50, 10 to 50, 15 to 50, 20 to 50, 25 to 50, 30 to 50, 35 to 50, 40 to 50, or 45 to 50. In some embodiments, “X” can be greater than 50. In some embodiments, “X” can range from 2 to 100, 10 to 100, 20 to 100, 10 to 200, 20 to 200, 50 to 200, 10 to 300, 20 to 300, or 50 to 300.

A thread layer, for example thread layer 200, can comprise any suitable number of thread lines. In some embodiments, a thread layer can comprise 10 or more thread lines. In some embodiments, a thread layer can comprise 20 or more thread lines. In some embodiments, a thread layer can comprise 50 or more thread lines. In some embodiments, a thread layer can comprise 100 or more thread lines. In some embodiments, a thread layer can comprise 200 or more thread lines. In some embodiments, a thread layer can comprise 300 or more thread lines. In some embodiments, a thread layer can comprise 500 or more thread lines. In some embodiments, a thread layer can comprise a number of thread lines in a range of 10 to 300. For example, a thread layer can comprise 10 to 300, 50 to 300, 100 to 300, or 150 to 300 thread lines. In some embodiments, a thread layer can comprise 10 to 500 thread lines. In some embodiments, a thread layer can comprise 100 to 500 thread lines. In some embodiments, a thread layer can comprise 100 to 1000 thread lines.

In some embodiments, thread lines 204 can be bonded at anchor points 290. In such embodiments, thread lines 204 can be bonded at anchor points 290 via an adhesive, a bonding layer, thermal (conductive or convective) heat (for example, in a heat press or oven), IR (infrared) heating, laser heating, microwave heating, steam, a mechanical fastener (for example, a clip), hook and loop fasters, needle-punching, hydro-entanglement, ultrasonic/vibratory entanglement, felting, knotting, chemical bonding with a catalyst of biomaterial, adhesive spraying (for example, CNC adhesive spray deposition), or by pushing one thread line through the other thread line(s).

In some embodiments, thread lines 204 can be directly bonded together at anchor points 290. In some embodiments, thread lines 204 can be directly bonded together at anchor points 290 via a polymeric material of continuous thread 202. For example, heat and/or pressure can be applied to directly bond thread lines 204 at anchor points 290. In embodiments where heat and/or pressure is utilized to directly bond the polymeric material of thread lines 204, the thread lines 204 can be thermally fused together at one or more anchor points 290. In embodiments comprising direct bonding of thread lines 204 at anchor points 290, thread lines 204 can be directly bonded at anchor points 290 without the use of an adhesive or bonding layer.

In some embodiments, thread lines 204 can be bonded together via a bonding layer. In some embodiments, thread lines 204 can be bonded together at anchor points 290 via a bonding layer. In such embodiments, the bonding layer can be, for example, a laminated layer, an adhesive layer, a stitched layer, a cured layer, a screen-printed layer, or a blown fiber layer. In some embodiments, the blown fiber layer can comprise polymeric fibers that can bond thread lines 204.

In some embodiments, thread lines 204 can be bonded together without the use of a bonding layer. For example, in some embodiments, thread lines 204 can be directly bonded together via, for example, but not limited to, direct local bonding via material(s) of thread lines 204, needle punching, hydro-entanglement, and ultrasonic/vibratory entanglement.

In some embodiments, thread lines 204 can be bonded at points where two or more thread lines 204 overlap in thread layer 200 (i.e., intersection points 206). Thread lines 204 can be bonded at intersection points 206 via an adhesive, a bonding layer, thermal (conductive or convective) heat (for example, in a heat press or oven), IR (infrared) heating, laser heating, microwave heating, steam, a mechanical fastener (for example, a clip), hook and loop fasters, needle-punching, hydro-entanglement, ultrasonic/vibratory entanglement, felting, knotting, chemical bonding with a catalyst of biomaterial, adhesive spraying (for example, CNC adhesive spray deposition), or by pushing one thread line through the other thread line(s). Intersection points 206 for thread lines can be referred to as “overlap points” or “points of overlap.”

In some embodiments, thread lines 204 can be directly bonded together at intersection points 206. In some embodiments, thread lines 204 can be directly bonded together at intersection points 206 via the polymeric material of continuous thread 202. In embodiments comprising direct bonding of thread lines 204 at intersection points 206, thread lines 204 can be bonded at intersection points 206 without the use of an adhesive or bonding layer. For example, heat and/or pressure can be applied to thread layer 200 to directly bond thread lines 204 at intersection points 206. In embodiments where heat and/or pressure is utilized to directly bond the polymeric material of thread lines 204, the thread lines 204 can be thermally fused together at one or more intersection points 206.

In some embodiments, a bonding layer can bond thread lines 204 together at a plurality of intersection points 206 within thread layer 200. In such embodiments, the bonding layer can be, for example, a laminated layer, an adhesive layer, a stitched layer, a cured layer, a screen-printed layer, or a blown fiber layer comprising polymeric fibers that can bond thread lines 204.

In some embodiments, bonding of continuous thread(s) for a thread layer or thread pattern can set the thread layer or thread pattern such that the thread layer or thread pattern forms a portion of an article of apparel. In some embodiments, bonding of continuous thread(s) for a thread layer or thread pattern can set the thread layer or thread pattern so that the thread layer or thread pattern can be shaped into a structure that forms a portion of an upper for an article of footwear. In some embodiments, after bonding of continuous thread(s) for a thread layer or thread pattern, the thread layer or thread pattern can be cut to define a shape utilized to form a portion of an upper for an article of apparel. For example, in some embodiments, a thread layer or thread pattern can be cut to define a perimeter shape for a portion of an upper for an article of apparel. As another example, in some embodiments, a thread layer or thread pattern can be cut to define a shape for at least one of a biteline, a collar, or a throat of an upper for an article of footwear.

In some embodiments, continuous thread 202 can comprise overlaying thread lines 204. As used herein, “overlaying thread lines” means two or more thread lines that follow the same path between two respective anchor points. Overlaying thread lines need not be overlaid directly over each other. Two or more thread lines are considered overlaying as long as they extend between the same two anchor points.

In some embodiments, the thread lines 204 of thread layer 200 are not woven, knitted, or braided together. In such embodiments, thread lines 204 can be referred to as “non-woven,” “non-knitted,” and “non-braided” thread lines. Additionally or alternatively, in some embodiments, the thread lines 204 of thread layer 200 are not be embroidered threads stitched to a base layer. In such embodiments, thread lines 204 can be referred to as “non-embroidered” thread lines.

Each thread layer 200, 220, 240 (or a thread pattern) can be defined by one or more threads comprising a plurality of thread lines crossing over each other at points of overlap between two or more of the thread lines. Each thread line of a thread layer can extend continuously across the thread layer (or thread pattern) (for example, between one side of a thread border 250 and another side of the thread border 250). Thread lines extending continuously across the thread layer (or thread pattern) are not woven, knitted, or braided threads. Similarly, thread lines extending continuously across the thread layer (or thread pattern) are not embroidered threads stitched to a base layer. Rather, the thread lines, and therefore the thread layer(s), are formed by winding thread around anchor points as described herein.

In some embodiments, thread lines extending continuously across the thread layer (or thread pattern) can extend continuously without forming a knitted structure, a woven structure, or a braided structure between opposing ends of the thread lines. In some embodiments, thread lines extending continuously across the thread layer (or thread pattern) can extend continuously without forming a knitted structure, a woven structure, or a braided structure along a distance greater than or equal to at least 90% of the length of the thread lines measured between opposing ends of the thread lines. In some embodiments, thread lines extending continuously across the thread layer (or thread pattern) can extend continuously without forming an embroidered structure between opposing ends of the thread lines. In some embodiments, thread lines extending continuously across the thread layer (or thread pattern) can extend continuously without forming an embroidered structure along a distance greater than or equal to at least 90% of the length of the thread lines measured between opposing ends of the thread lines.

In some embodiments, continuous thread 202 can be a polymer thread. As used herein, “polymer thread” means a thread composed at least in part of a polymeric material at the time of its formation. For example, the polymer of a “polymer thread” does not include flowable liquid polymer impregnated after formation of the thread, as described herein. In some embodiments, a polymer thread can be composed entirely of one or more polymeric materials. In some embodiments, a polymer thread can comprise a polymeric material coated around a core (which can or may not be composed of a polymeric material). In such embodiments, the core can be encapsulated by the coating material. In some embodiments, a polymer thread can comprise a non-polymer core coated, covered, or encapsulated with a polymeric material. In some embodiments, a polymer thread can comprise a polymer core coated, covered, or encapsulated with a non-polymeric material. In some embodiments, a polymer thread can be a braided thread with one or more braids composed of a polymeric material. In some embodiments, the polymeric material(s) of a polymer thread can be thermoplastic material(s).

In some embodiments, continuous thread 202 can be a thread coated with an activatable agent, for example a heat activated adhesive or a UV-activated adhesive. In some embodiments, a CNC machine for winding a continuous thread 202 with an activatable agent coating can comprise a robotic arm for activating the coating as continuous thread 202 is being wound around anchor points 290.

Suitable polymeric materials for polymer threads discussed herein comprise, but are not limited to, thermoplastic polyurethane (TPU), a rubber, and silicone. In some embodiments, the TPU can be recycled TPU. In some embodiments, the polymeric material can be a photo-reactive (infrared or ultraviolet light reactive) polymeric material, such as a photo-reactive TPU. In some embodiments, the polymeric material can be soluble (for example, water-soluble). In embodiments comprising polymer threads with a coated core, suitable materials for the core comprise, but are not limited to, polyester, nylon, ultra-high molecular weight polyethylene (for example, DYNEEMA® (a type of ultra-high molecular weight polyethylene)), carbon fiber, KEVLAR® (a type of para-aramid), bioengineered woven, knit or layered materials (for example, synthetic spider silk), woven, knit or layered plant based materials, cotton, wool, and natural or artificial silk. In some embodiments, polymer threads can be thermoplastic polyurethane coated polyester threads. In some embodiments, continuous thread 202 can be a non-polymer thread composed of non-polymer materials, such as carbon fiber, cotton, wool, or silk. In some embodiments, continuous thread 202 can be a thread composed of a biomaterial, such as mango yarn or bio-silk. In some embodiments, polymer threads can be a thermoplastic melt yarn, polymer yarn with non-melt core, and other similar types of yarn.

In some embodiments, the polymeric material for polymer threads can comprise a melting temperature in a range of greater than or equal to 110° C. to less than or equal to 150° C. In such embodiments, the polymeric material can be referred to as a “low melting temperature polymeric material.”

In some embodiments, continuous thread 202 can be a plied thread. In some embodiments, the plied thread can be plied while winding thread 202.

Thread patterns as described herein can comprise any number of thread layers. For example, a thread pattern can comprise two or more, three or more, four or more, five or more, six or more, seven or more, eight or more, nine or more, ten or more, fifteen or more, or twenty or more thread layers. For example, a thread pattern can comprise thread layer 200, thread layer 220, and thread layer 240.

Continuous threads of any thread layer (for example, thread layers 220 and 240) can be wound around and extended between anchor points 290 in the same fashion as described above for continuous thread 202. Further, thread lines of the continuous threads of any thread layer (for example, thread layers 220 and 240) can be bonded in the same manner as described above for thread layer 200.

Like continuous thread 202, continuous threads for other thread layers (for example, threads 222 and 242) can comprise a plurality of thread lines (for example, thread lines 224 and 244) wound around and extending between two respective anchor points. In some embodiments, continuous threads of different thread layers can be the same thread material. In some embodiments, continuous threads of different thread layers can be composed of different thread materials. In such embodiments, the materials for different continuous threads in a thread pattern can be selected to provide targeted characteristics to areas of a thread pattern, and therefore an article of apparel. In some embodiments, the denier of continuous threads in different thread layers within a thread pattern can be selected to provide varying degrees of a characteristic (for example, strength or stretchability) to different areas of the thread pattern.

In embodiments comprising a thread pattern with a plurality of thread layers, the plurality of thread layers can be layered over each other. For example, thread layer 200 can define a first layer of a thread pattern and a second thread layer 220 can define a second layer of the thread pattern. Different thread layers of a thread pattern can be disposed over each other in areas of overlap between the two thread layers. For example, a first thread layer 200 can be disposed over second thread layer 220, or vice versa, in areas of overlap between the two thread layers.

In embodiments comprising a thread pattern with a plurality of thread layers, the plurality of thread layers can be bonded to each other in the thread pattern. In some embodiments, one or more of the layers can be directly bonded to each other via the polymeric material of a continuous thread defining thread lines for at least one of the layers. In some embodiments, one or more of the layers can be bonded via a bonding layer. In such embodiments, the bonding layer can be, for example, a laminated layer, an adhesive layer, a stitched layer, a cured layer, a screen-printed layer, or a blown fiber layer. In some embodiments, the bonding layer can be a non-woven bonding layer.

In some embodiments, one or more thread layers of a thread pattern can serve to bond other thread layers of the thread pattern together. In such embodiments, these one or more thread layers can be wound using a polymeric thread, which when heated, bonds other layers of the thread pattern together at anchor points and/or intersection points between continuous threads. For example, in a thread pattern comprising three thread layers, one of the three thread layers (for example, the middle thread layer) can be a wound using a polymeric thread that serves to bond all three thread layers together. In some embodiments, one or more thread layers of a thread pattern can be defined by a wound continuous thread coated or impregnated with an adhesive. In some embodiments, the adhesive can be activated with the application of heat. In some embodiments, the adhesive can be a dissolvable adhesive that, when contacted with a solvent, such as water, fully or partially dissolves to bond thread layers together.

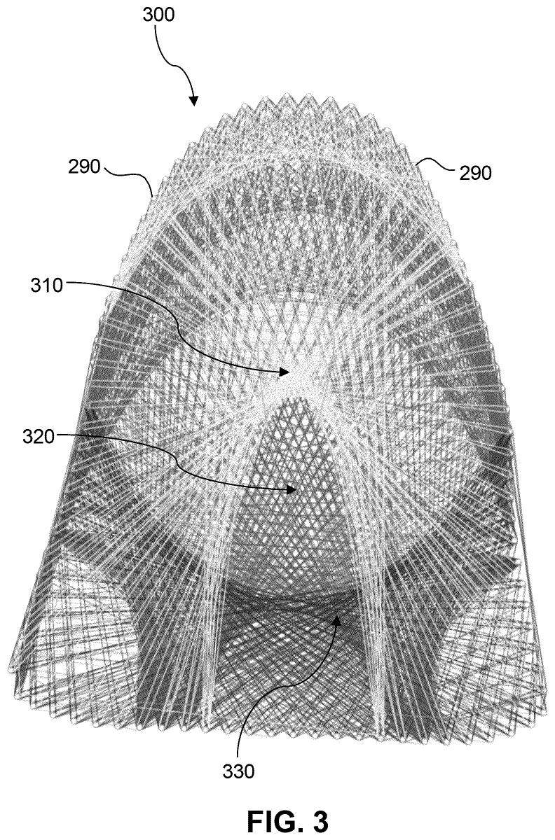

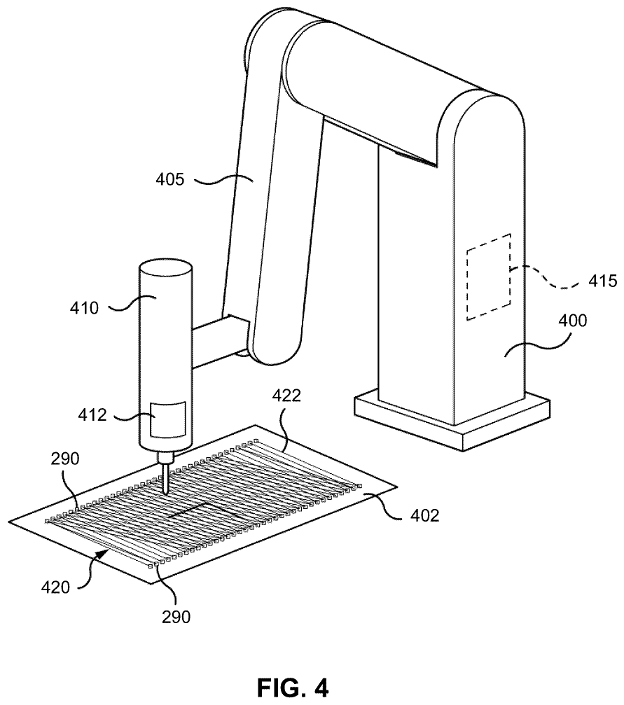

FIG. 3 illustrates a thread pattern 300 according to some embodiments. Thread pattern 300 can comprise multiple thread layers, for example, first thread layer 310, second thread layer 320, and third thread layer 330. Like thread layers 200, 220, and 240, thread layers 310, 320, 330 can each comprise a continuous thread wound around a plurality of anchor points 290. Thread pattern 300 can be a thread pattern produced using the apparatuses and methods described with respect to FIGS. 4-17. In some embodiments, first thread layer 310, second thread layer 320, and third thread layer 330 can each comprise a different continuous thread. In some embodiments, one or all of the different continuous threads can comprise a different material from that of other of the continuous threads.

In some embodiments, first thread layer 310, second thread layer 320, and third thread layer 330 can be wound sequentially. For example, first thread layer 310 can be wound around anchor points 290 first, followed by second thread layer 320 being wound around anchor points 290, and then third thread layer 330 being wound around anchor points 290. While FIG. 3 shows three thread layers 310, 320, 330, thread pattern 300 can comprise any number of thread layers, such as two, four, five, six, seven, eight, nine, ten, eleven, or twelve thread layers.

As shown in FIG. 3, each of first, second, and third thread layers 310, 320, 330 can be wound using different winding patterns (defined by the angles thread lines in a thread layer extend relative to a perimeter of the thread layer and relative to one another). The winding pattern(s) can be selected to influence a variety of characteristics of a resulting thread layer 310, 320, 330 or thread pattern 300, for example, durability, stiffness, weight, tackiness, texture, haptics, and/or air permeability.

FIG. 4 shows a CNC machine 400 for winding continuous threads according to some embodiments. In some embodiments, CNC machine 400 can comprise a robotic arm 405 for winding a thread layer 420 comprising thread lines 422 around anchor points 290, which can be projections (for example, pins) coupled to or integrally formed with support plate 402. Thread layer 420 in FIG. 4 is a representative exemplary thread layer. CNC machine 400 can also be used to wind a thread pattern comprising a plurality of thread layers.

Robotic arm 405 can comprise a thread spool 410 for threading and winding thread lines 422 of thread layer 420 around anchor points 290. In some embodiments, CNC machine 400 can comprise a thread tensioner 412 configured to apply a desired tension to thread(s) that are wound around anchor points 290. CNC machine 400 can comprise a controller 415 configured to wind a desired thread layer 420 around anchor points 290 using a thread model and input data. In some embodiments, controller 415 can control tensioner 412 to wind thread(s) at desired tensions. Controller 415 can comprise components of computer system 1900 discussed herein.

In some embodiments, CNC machine 400 can comprise a winding assembly comprising a plurality of thread spools 410 for threading and winding a plurality of different threads for a thread pattern. In some embodiments, the winding assembly can comprise a plurality of tensioners 412 configured to apply a desired tension to threads from different thread spools 410. In some embodiments, CNC machine 400 with the winding assembly can wind a plurality of threads from a plurality of thread spools 410 simultaneously when winding a thread pattern. In some embodiments, the winding assembly can be used to simultaneously wind “overlaying thread lines” from a plurality of thread spools 410. By simultaneously winding threads from a plurality of thread spools 410, the speed at which a desired thread pattern can be created can be increased.

In some embodiments, CNC machine 400 can comprise two or more robotic arms 405 for winding a plurality of threads simultaneously. In such embodiments, the two or more robotic arms 405 can wind different threads in different regions of a thread pattern simultaneously.

In some embodiments, the input to controller 415 can comprise one or more files specifying a winding pattern of thread layer 420. In some embodiments, the one or more files can comprise a file describing the positions of anchor points 290 in two dimensions (2D) or three dimensions (3D), depending on the structure of support plate 402. In such embodiments, each of anchor points 290 can be associated with a unique identifier (e.g., a number or alphanumeric code) that is specified in the file. In some embodiments, the one or more files can be JSON files, but the one or more files are not limited to a particular format. In some embodiments, one or more processors of or in communication with controller 415 (for example, processor device 1904) can interpret the contents of the one or more files into CNC G-code commands that control the movement of robotic arm(s) 405. In some embodiments, the contents of the one or more files can also comprise instructions to change a continuous thread to another continuous thread, for example, to transition between winding a first thread layer and winding a second thread layer. In some embodiments, the contents of the one or more files can also comprise instructions to control tensioner(s) 412 to wind thread(s) at desired tension(s).

In some embodiments, tensioner 412 can be a mechanical tensioning device with digitally controlled impedance that is used to dynamically control how tight a thread is fed through a winding machine (for example, CNC machine 400). In some embodiments, thread can be run through tensioner 412 before it exits thread spool 410, thereby giving an exact tension as it is fed out. In some embodiments, thread can be run through tensioner 412 after it exits a thread spool to give the thread a desired tension. In some embodiments, the tension value for thread can be changed dynamically by adjusting the voltage in tensioner 412. In some embodiments, tensioner 412 can be a manually adjustable tensioner. In some embodiments, tensioner 412 can comprise a spring configured to adjust the amount of tension applied to thread(s). The spring can be manually controlled or digitally controlled.

Once thread layer 420 is mechanically set by, for example, bonding thread lines 422 to one another, thread layer 420 can be removed from support plate 402. In some embodiments, removing thread layer 420 from support plate 402 can comprise lifting thread layer 420 from anchor points 290. In some embodiments, removing thread layer 420 from support plate 402 can comprise cutting a portion of thread layer 420 from support plate 402. In some embodiment, the cutting process can comprise a laser cutting process.

While FIG. 4 shows a CNC machine 400, in some embodiments, a thread layer or thread pattern can be wound around anchor points on a support plate (for example, anchor points 290 of support plate 402) manually.

Additionally, while FIG. 4 shows a flat support plate 402 and CNC machine 400 comprising a robotic arm 405, alternative configurations of CNC machine 400 are contemplated. For example, in some embodiments, support plate 402 can be in the form of one or more rotating objects (for example, wheel(s), a drum, a rotating plate, etc.) as disclosed in U.S. patent application Ser. No. 18/400,574, filed Dec. 29, 2023 and titled CIRCULAR WINDING APPARATUS AND METHOD, and U.S. patent application Ser. No. 18/400,620, filed Dec. 29, 2023 and titled ROTATIONAL WINDING APPARATUS AND METHOD, the disclosures of which are incorporated by reference herein in their entireties. In such embodiments, CNC machine 400 can comprise one or more translating components (for example, a thread guide) that wind a continuous thread around anchor points of a rotating object as the object rotates, as disclosed in U.S. patent application Ser. Nos. 18/400,574 and 18/400,620.

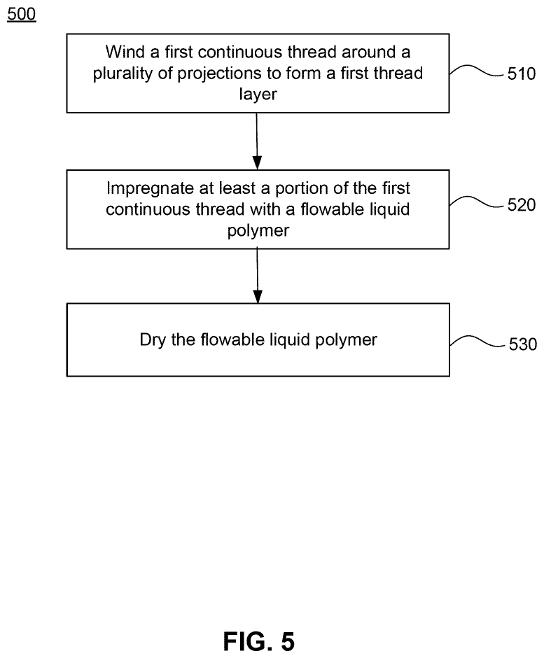

FIG. 5 shows a method 500 of making an article of apparel (for example, article of apparel 100) according to some embodiments.

Unless stated otherwise, the steps of method 500 need not be performed in the order set forth herein. Additionally, unless specified otherwise, the steps of method 500 need not be performed sequentially. The steps can be performed in a different order or simultaneously. For example, step 520 can be performed before, after, or simultaneously with step 510. Likewise, in cases in which step 520 is performed before step 510, step 530 can be partially performed before step 510 as described herein.

Step 510 comprises winding a first continuous thread (for example, first continuous thread 130) around a plurality of projections (for example, anchor points 290, which can be projections) to form a first thread layer (for example, of thread layer(s) 122) comprising a plurality of thread lines (for example, thread lines 132).

Step 520 comprises impregnating at least a portion of the first continuous thread with a flowable liquid polymer. As used herein with regard to any of the disclosed methods (for example, methods 500, 1000, and/or 1600), “impregnating” a thread with a flowable liquid polymer means causing the flowable liquid polymer to be absorbed into the thread. Impregnated flowable liquid polymer moves past the surface of the thread to occupy an interior of the thread. Additionally, as used herein with regard to any of the disclosed methods (for example, methods 500, 1000, and/or 1600), in some embodiments, impregnating a thread with a flowable liquid polymer can comprise “wetting out” the thread with the flowable liquid polymer. As used herein, “wetting out” a thread in a flowable liquid polymer means impregnating the thread with the flowable liquid polymer to a saturation point, meaning that, barring a substantial change in temperature and/or pressure conditions experienced by the thread, the thread does not absorb more of the flowable liquid polymer when submerged in the flowable liquid polymer.

A flowable liquid polymer being absorbed into a thread comprises the flowable liquid polymer being absorbed by the structure of the thread and/or inhabiting spaces within the structure of the thread at locations interior of a perimeter of the thread. For example, a flowable liquid polymer being absorbed into a thread comprises the flowable liquid polymer being absorbed by fibers of the thread and/or inhabiting spaces between fibers of the thread at a location interior of a perimeter of the thread. The fibers can comprise any material disclosed herein for the formation of a continuous thread.

In some embodiments a flowable liquid polymer can be a polymer with a viscosity under 3,000 centipoise (cps), for example, under 2,500 cps, under 2,000 cps, under 1,500 cps, or under 1,000 cps. In some embodiments, the flowable liquid polymer can have a viscosity in the range of 1 cps to 3,000 cps, including subranges. For example, in some embodiments, the flowable liquid polymer can have a viscosity in the range of 1 cps to 2,500 cps, 1 cps to 2,000 cps, 1 cps to 1,500 cps, 1 cps to 1,000 cps, 10 cps to 1,000 cps, 50 cps to 1,000 cps, 100 cps to 1,000 cps, 150 cps to 1,000 cps, 200 cps to 1,000 cps, 250 cps to 1,000 cps, 300 cps to 1,000 cps, 350 cps to 950 cps, 400 cps to 900 cps, 450 cps to 850 cps, 500 cps to 800 cps, 550 cps to 750 cps, 600 cps to 700 cps, 500 cps to 3000 cps, 500 cps to 2000 cps, 500 cps to 1,500 cps, 1000 cps to 3000 cps, 1000 cps to 2000 cps, or 2000 cps to 3000 cps.

In some embodiments, the viscosity of a flowable liquid polymer as defined above can be assessed when the polymer is at room temperature (20° C.) and under normal atmospheric pressure at sea level (about 1013 millibars (mb)). However, this is not the case for all embodiments. In some embodiments, the viscosity of a flowable liquid polymer can be assessed at the time of impregnating at least a portion of a continuous thread with the polymer, regardless of the temperature and/or pressure conditions experienced by the polymer. For example, in some embodiments, the polymer can be heated to convert the polymer to a flowable liquid polymer before impregnating a continuous thread with the polymer.

In some embodiments, the flowable liquid polymer can comprise an epoxy resin. However, the flowable liquid polymer can comprise any suitable flowable liquid polymer resin. In some embodiments, the flowable liquid polymer can comprise a two part epoxy that comprises an epoxy resin and a hardener.

In some embodiments, impregnating at least the portion of the first continuous thread with the flowable liquid polymer can comprise applying the flowable liquid polymer to the first continuous thread while winding the first continuous thread around the plurality of projections. In such embodiments, the flowable liquid polymer can be applied while one or more thread lines of the first thread layer are yet to be formed by winding the first continuous thread around the plurality of projections.

Alternatively or additionally, in some embodiments, impregnating at least the portion of the first continuous thread with the flowable liquid polymer can comprise applying the flowable liquid polymer to at least the portion of the first continuous thread before winding the first continuous thread around the plurality of projections. In such embodiments, the flowable liquid polymer can be applied before any thread line of the first thread layer is formed. In some embodiments, the impregnated flowable liquid polymer can be partially cured and can partially solidify before winding the first continuous thread around the plurality of projections. Alternatively or additionally to partial curing, the first continuous thread can be held at a temperature (e.g., a reduced temperature) at which the impregnated flowable liquid polymer's viscosity is increased during winding. Regardless of the method, increasing the viscosity of the polymer can secure the polymer within the first continuous thread during winding.

Alternatively or additionally to polymer application during and/or before winding, in some embodiments, impregnating at least the portion of the first continuous thread with the flowable liquid polymer can comprise applying the flowable liquid polymer to thread lines (for example, thread lines 132) of the first thread layer after winding the first continuous thread around the plurality of projections. In such embodiments, the flowable liquid polymer can be applied after all thread lines of the first thread layer are formed by winding the first continuous thread around the plurality of projections.

In some embodiments, applying the flowable liquid polymer to individual thread lines can comprise applying the flowable liquid polymer via a nozzle (for example, a nozzle of CNC machine 400) that can follow the course of the first continuous thread and dispense the flowable liquid polymer onto the first continuous thread while or after the first continuous thread is being wound around the plurality of projections. In some embodiments, the nozzle can move concurrently with a portion of CNC machine 400 that dispenses the first continuous thread. In some embodiments, the nozzle can be a spray nozzle that sprays the flowable liquid polymer onto the first continuous thread while it is being wound or after. In any event, the pressure and/or amount of flowable liquid polymer expelled from the nozzle at a portion of the first continuous thread is sufficient to impregnate at least the portion of the first continuous thread with the flowable liquid polymer.

In some embodiments, applying the flowable liquid polymer to at least the portion of the first continuous thread can comprise soaking at least the portion of the first continuous thread in the flowable liquid polymer. For example, at least the portion of the first continuous thread can be pulled through a bath of the flowable liquid polymer before or during winding the first continuous thread around the plurality of projections.

In some embodiments, applying the flowable liquid polymer to at least the portion of the first continuous thread can comprise applying a sponge holding the flowable liquid polymer to at least the portion of the first continuous thread. In some embodiments, the sponge can be coupled to a movable component of CNC machine 400 or can be operated manually.

In some embodiments, applying the flowable liquid polymer to at least the portion of the first continuous thread can comprise applying a brush holding the flowable liquid polymer to at least the portion of the first continuous thread. In some embodiments, the brush can be coupled to a movable component of CNC machine 400 or can be operated manually.

In some embodiments, impregnating at least the portion of the first continuous thread with the flowable liquid polymer can at least partially embed individual thread lines of the first thread layer in the flowable liquid polymer. In some embodiments, impregnating at least the portion of the first continuous thread with the flowable liquid polymer can completely embed individual thread lines of the first thread layer in the flowable liquid polymer.

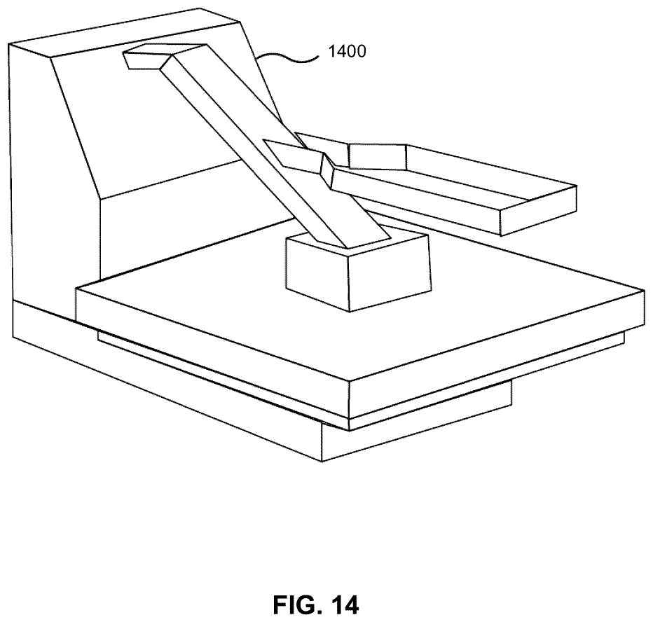

Step 530 comprises drying the flowable liquid polymer. In some embodiments, drying the flowable liquid polymer can comprise allowing the flowable liquid polymer to air dry without intentionally altering the temperature and/or humidity of the environment. In some embodiments, drying the flowable liquid polymer can comprise applying heat to the flowable liquid polymer. For example, heat can be applied via a heat press (for example, heat press 1400 of FIG. 14), an oven, moving the applied liquid polymer to a different environment, etc., to dry the flowable liquid polymer. In some embodiments, drying the flowable liquid polymer comprises curing the flowable liquid polymer into a solid state.

In some embodiments, drying the flowable liquid polymer in step 530 can comprise applying external pressure to the first continuous thread (e.g., using a vacuum bag 830, heat press 1400, or another component) to expel excess polymer. In some embodiments, the external pressure can be configured to create a target ratio of resulting polymer matrix to fiber of the first continuous thread.

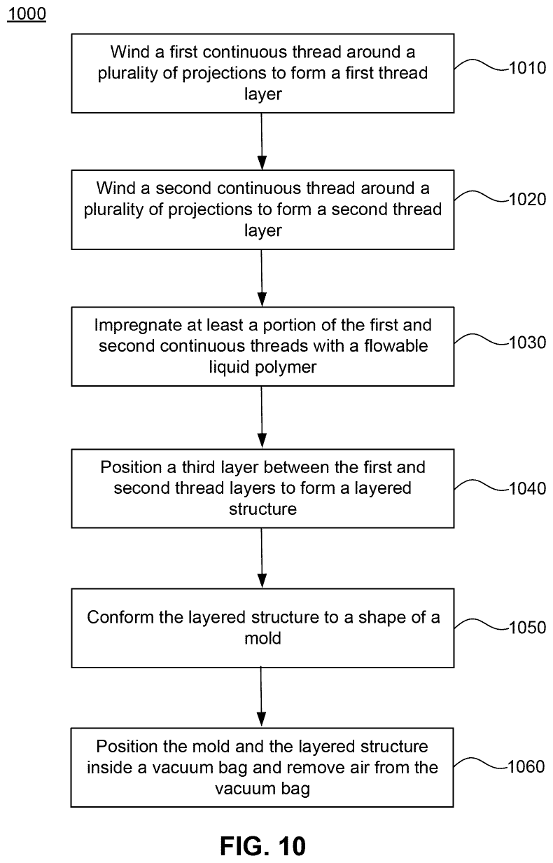

While a “first continuous thread” is discussed with reference to FIG. 5, a second continuous thread (for example, continuous thread 170) can be wound around a plurality of projections (either the same or different plurality of projections as the first continuous thread) to form a second thread layer, as discussed for example with respect to FIG. 10. In some embodiments, the methods for winding and impregnating the first continuous thread discussed with respect to FIG. 5 can be applied to the first and second continuous threads as discussed with respect to FIG. 10.

Accordingly, in some embodiments, method 500 can comprise multiple winding steps 510 and/or multiple impregnating steps 520. For example, a first continuous thread can be wound in a first winding step 510 and then at least a portion of the first continuous thread can be impregnated with a flowable liquid polymer in a first impregnating step 520. Then a second continuous thread can be wound in a second winding step 510 and at least a portion of the second continuous thread can be impregnated with the flowable liquid polymer in a second impregnating step 520. As another example, a first continuous thread can be wound in a first winding step 510 and a second continuous thread (or more continuous threads) can be wound in a second winding step 510 (or more winding steps 510). Then, after the winding steps, an impregnating step 520 can be performed to impregnate at least a portion of the first and second continuous threads (or more continuous threads) with the flowable liquid polymer.

Additionally, step 530 can be performed after each impregnating step 520 (if there are multiple impregnating steps 520), or only once after all impregnating steps 520 are complete.

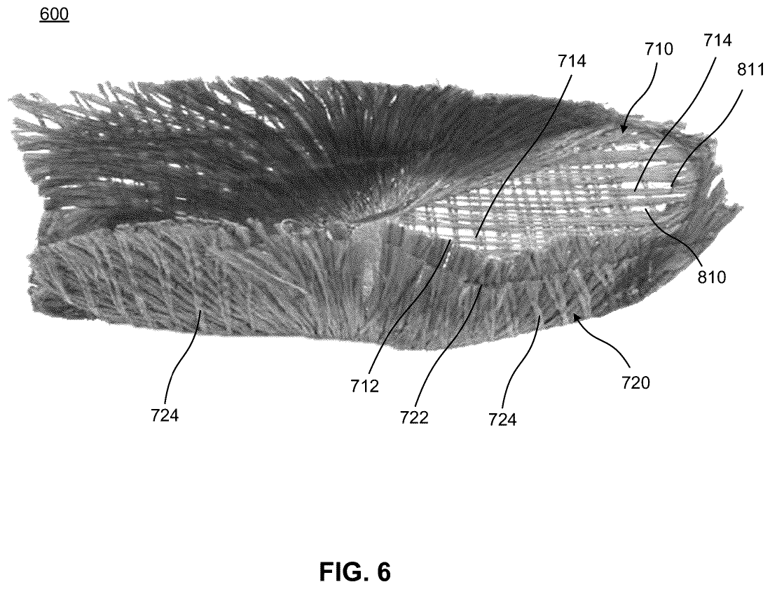

FIG. 6 shows a layered structure 600 comprising first thread layer(s) 710 and second thread layer(s) 720 according to some embodiments. First thread layer(s) 710 can comprise one or more thread layers as described herein (for example, one or more thread layers of thread layer(s) 122, 200, 220, and 240). Accordingly, first thread layer(s) 710 can comprise either a single thread layer or can comprise a thread pattern (for example, thread pattern 300). Likewise, second thread layer(s) 720 can comprise one or more thread layers as described herein (for example, one or more thread layers of thread layer(s) 122, 200, 220, and 240). Accordingly, second thread layer(s) 720 can comprise either a single thread layer or can comprise a thread pattern (for example, thread pattern 300).

As shown in FIG. 6, first thread layer(s) 710 can be arranged adjacent one another. For example, in some embodiments, first thread layer(s) 710 can be nested within second thread layer(s) 720. In some embodiments, first thread layer(s) 710 and second thread layer(s) 720 can be thread layers that at least a portion of which have been impregnated with a flowable liquid polymer, for example, an epoxy resin. For example, in some embodiments, first thread layer(s) 710 and second thread layer(s) 720 can be soaked in the flowable liquid polymer, either by submersion or by external application of the flowable liquid polymer to the first and second thread layer(s) 710, 720. In some embodiments, first thread layer(s) 710 and second thread layer(s) 720 can be wetted out with the flowable liquid polymer.

As shown in FIG. 6, first thread layer(s) 710 can comprise a first perimeter edge 712. First perimeter edge 712 of first thread layer(s) 710 can be analogous to one or more thread borders 250 of thread layers 200, 220, and/or 240. For example, first perimeter edge 712 can be where the one or more thread layers of first thread layer(s) 710 were cut. If first thread layer(s) 710 comprises more than one thread layer, individual thread layers of first thread layer(s) 710 can share the first perimeter edge 712. Likewise, second thread layer(s) 720 can comprise a second perimeter edge 722. Second perimeter edge 722 of second thread layer(s) 720 can be analogous to one or more thread borders 250 of thread layers 200, 220, and/or 240. For example, second perimeter edge 722 can be where the one or more thread layers of second thread layer(s) 720 were cut. If second thread layer(s) 720 comprises more than one thread layer, in some embodiments, individual thread layers of second thread layer(s) 720 can share the second perimeter edge 722

First thread layer(s) 710 (and individual thread layers of first thread layer(s) 710) can comprise a plurality of first thread lines 714. In some embodiments, first thread lines 714 can extend continuously from a first side of first perimeter edge 712 to a second side of first perimeter edge 712. Likewise, second thread layer(s) 720 (and individual thread layers of second thread layer(s) 720) can comprise a plurality of second thread lines 724. In some embodiments, second thread lines 724 can extend continuously from a first side of second perimeter edge 722 to a second side of second perimeter edge 722.

First and second thread lines 714, 724 can be non-woven, non-knitted, non-braided, and non-embroidered thread lines, as described herein.

In some embodiments, as shown in FIGS. 6-8, layered structure 600 can comprise a third layer 810 between the first thread layer(s) 710 and the second thread layer(s) 720. In some embodiments, third layer 810 can comprise a different material than first and second thread layer(s) 710, 720. In some embodiments, the different material can comprise a foam material.

In some embodiments, the third layer 810 can comprise an injection molded part comprising a polymer such as thermoplastic polyurethane (TPU), nylon (PA), etc.; a 3D printed part comprising, for example, a lattice structure; an extruded part; or a metallic part, for example, a metallic sheet. In some embodiments, the third layer 810 can comprise a honeycomb structure.

While FIGS. 6-8 show third layer 810, in some embodiments, third layer 810 can be omitted. Additionally, while FIGS. 6-8 show first thread layer(s) 710 and second thread layer(s) 720, in some embodiments, first thread layer(s) 710 or second thread layer(s) 720 can be omitted while third layer 810 is included.

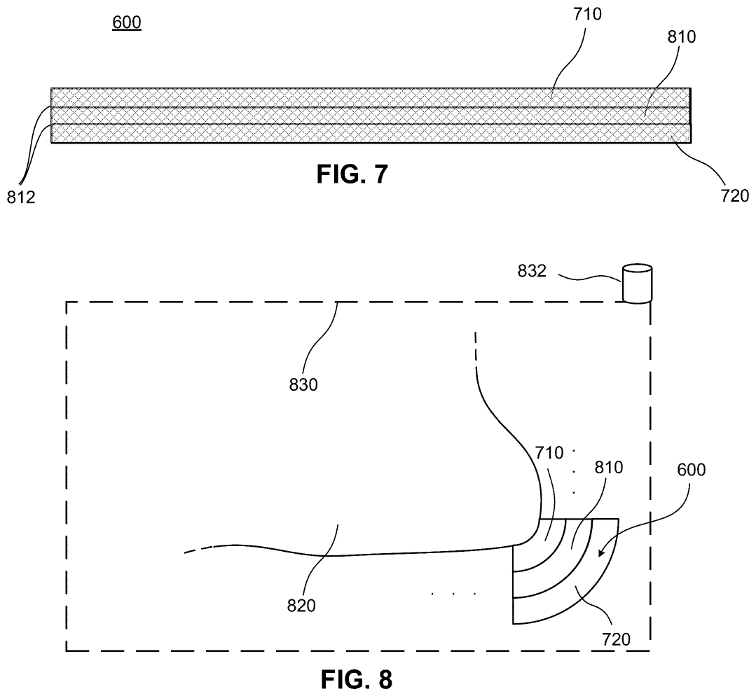

As described herein, at least a portion of the first and second thread layer(s) 710, 720 can be impregnated with a flowable liquid polymer (for example, by soaking first and second thread layer(s) 710, 720), which results in layered structure 600 comprising a polymer matrix 812 (shown as checkered lines in FIG. 7). Polymer matrix 812 can comprise the flowable liquid polymer in a dried state. The polymer matrix 812 can bond first thread lines 714 to one another, second thread lines 724 to one another, one or more first thread layer(s) 710 to third layer 810, and one or more second thread layer(s) 720 to third layer 810. In some embodiments, the polymer matrix 812 can bond one or more first thread layer(s) 710 to one or more second thread layer(s) 720. For example, the polymer matrix 812 can bond one or more first thread layer(s) 710 to one or more second thread layer(s) 720 around a perimeter 811 of third layer 810. In such embodiments, the polymer matrix 812, the one or more first thread layer(s) 710, and the one or more second thread layer(s) 720 can encase the third layer 810 between the one or more first thread layer(s) 710 and the one or more second thread layer(s) 720.

The polymer matrix 812 can be continuous (i.e., unbroken throughout layered structure 600) or discontinuous. In some embodiments, the polymer matrix 812 can comprise an epoxy.

In some embodiments, before the liquid flowable polymer impregnating first and second thread layer(s) 710, 720 fully dries, layered structure 600 can be conformed to the shape of an article of apparel or portion thereof. For example, as shown in FIG. 8, layered structure 600 can be conformed to a shape of a mold 820. While only a portion of layered structure 600 is shown, it should be understood that layered structure can wrap around all or a significant portion of mold 820. The mold 820 can be shape of any article of apparel or portion thereof. In some embodiments, mold 820 can comprise a shoe last.

In some embodiments, once layered structure 600 is positioned adjacent mold 820, layered structure 600 and mold 820 can be positioned inside a vacuum bag 830. Air can be removed from vacuum bag 830 to conform the first and second thread layer(s) 710, 720 and third layer 810 to the shape of mold 820. Additionally, pressure from vacuum bag 830 can cause the flowable liquid polymer within first and second thread layer(s) 710, 720 to pervade additional portions of layered structure 600 (for example, at least a portion of third layer 810). Pressure from vacuum bag 830 can ensure fibers of first and second thread layer(s) 710, 720 are fully wetted out, can remove voids or bubbles in the flowable liquid polymer that can result in weaknesses in layered structure 600, and can force excess flowable liquid polymer out of layered structure 600.

In some embodiments, the flowable liquid polymer can be dried to form polymer matrix 812 by removing layered structure 600 from vacuum bag 830.

In embodiments in which mold 820 comprises a shoe last, first thread layer(s) 710, second thread layer(s) 720, third layer 810, and polymer matrix 812 can form at least a portion of a shoe. For example, in some embodiments, first thread layer(s) 710, second thread layer(s) 720, third layer 810, and polymer matrix 812 can form at least a portion of a shoe upper, at least a portion of a shoe sole, or at least a portion of a shoe upper and at least a portion of a shoe sole. In some embodiments, first thread layer(s) 710, second thread layer(s) 720, third layer 810, and polymer matrix 812 can form one or more portions of an insole, a midsole, an outsole, or a combination thereof. In some embodiments in which first thread layer(s) 710, second thread layer(s) 720, third layer 810, and polymer matrix 812 form a portion of a shoe sole, no portions of first thread layer(s) 710 and/or second thread layer(s) 720 extend into a shoe upper to which the shoe sole is attached.

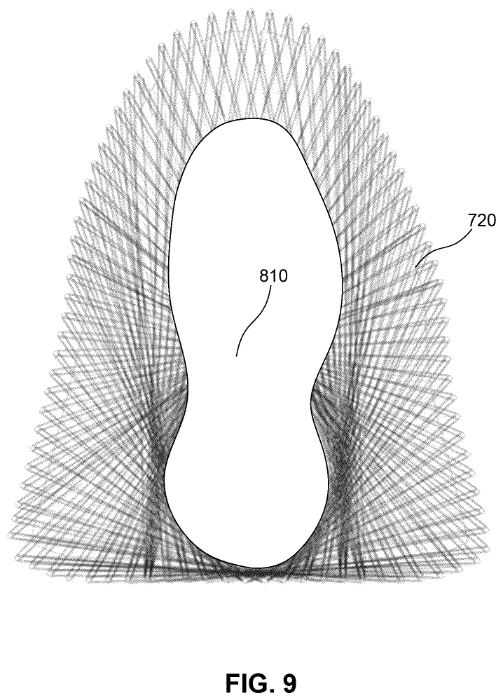

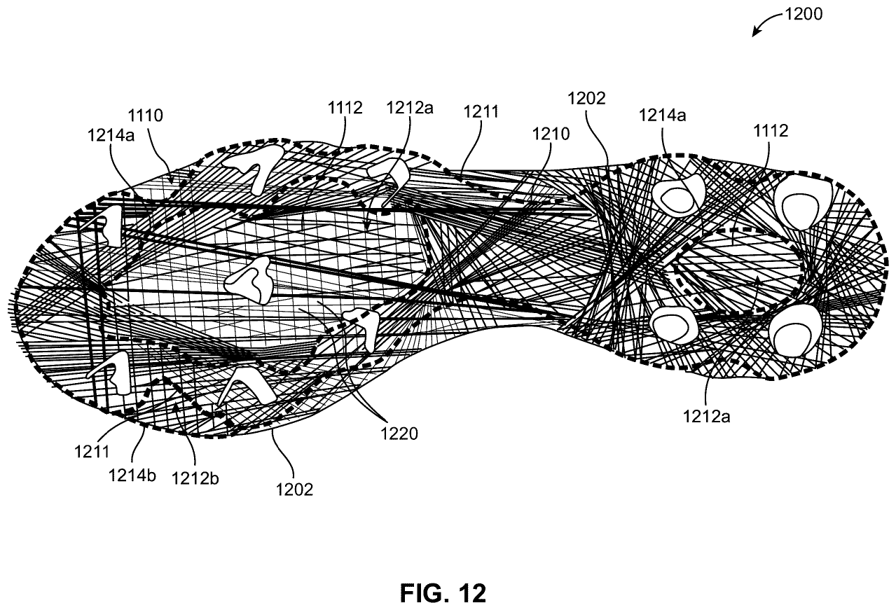

In some embodiments, third layer 810 can be shaped generally as a shoe sole, as shown for example in FIG. 9. In some embodiments, third layer 810 can comprise a padding component positioned between a wearer's foot and a shoe sole to cushion the wearer's foot. In some embodiments, third layer 810 can comprise a rigid plate having a rigidity greater than that of first and/or second thread layer(s) 710, 720. In such embodiments, the rigid plate of third layer 810 can form a portion of a shoe sole. In some embodiments, third layer 810 can comprise one or more openings (for example, like plate 1210 discussed with respect to FIG. 12).

While the use of layered structure 600 on a shoe is discussed, first thread layer(s) 710, second thread layer(s) 720, third layer 810, and polymer matrix 812 can form all or a portion of any type of apparel.

FIG. 10 shows a method 1000 of making an article of apparel (for example, article of apparel 100) according to some embodiments.

Unless stated otherwise, the steps of method 1000 need not be performed in the order set forth herein. Additionally, unless specified otherwise, the steps of method 1000 need not be performed sequentially. The steps can be performed in a different order or simultaneously. As one example, step 1020 of method 1000 need not be performed after step 1010. Rather, step 1020 can be performed simultaneously with or before step 1010. As another example, step 1030 need not be performed after steps 1010 and 1020. Rather, step 1030 can be performed simultaneously with or before steps 1010 and/or 1020. As another example, step 1040 need not be performed after step 1030. Rather, step 1040 can be performed before step 1030. As another example, step 1050 need not be performed before step 1060. Rather, step 1050 can be performed simultaneously with step 1060, for example, by operation of the vacuum bag of step 1060.

Further, method 1000 need not comprise all the steps illustrated. As one example, method 1000 need not comprise step 1060, for example, if components of the layered structure of step 1060 are bonded to one another using pressure applied by a press or manually, rather than by a vacuum bag. As another example, method 1000 need not comprise step 1040 (i.e., the layered structure need not comprise a third layer). As another example, method 1000 need not comprise step 1050, for example, if the layered structure is designed for use in an article of apparel that does not require pre-molding the layered structure to the shape of the article of apparel.

Steps of method 1000 can overlap with steps of method 500. For example, steps of method 1000 related to winding a first continuous thread and impregnating at least a portion of the first continuous thread with a flowable liquid polymer can be at least partially the same as steps of method 500. Accordingly, some embodiments of method 500 can form parts of method 1000.

Step 1010 comprises winding a first continuous thread around a plurality of projections (for example, anchor points 290, which can be projections) to form a first thread layer (for example, a thread layer of first thread layer(s) 710) comprising a plurality of thread lines (for example, first thread lines 714). As discussed herein, each thread line can extend between two respective projections, either before the first thread layer is cut or otherwise removed from the plurality of projections to form layered structure 600, or if the first thread layer remains coupled to the plurality of projections and they are removed from a support structure (for example, support plate 402) to form layered structure 600.

Step 1020 comprises winding a second continuous thread around a plurality of projections (for example, anchor points 290, which can be projections) to form a second thread layer (for example, a thread layer of second thread layer(s) 720) comprising a plurality of thread lines (for example, second thread lines 724). As discussed herein, each thread line can extend between two respective projections, either before the second thread layer is cut or otherwise removed from the plurality of projections to form layered structure 600, or if the first thread layer remains coupled to the plurality of projections and they are removed from a support structure (for example, support plate 402) to form layered structure 600.

Step 1030 comprises impregnating at least a portion of the first and second continuous threads with a flowable liquid polymer. The flowable liquid polymer can be the same as or similar to the flowable liquid polymer described with respect to method 500. The flowable liquid polymer can be any suitable flowable liquid polymer material discussed herein. For example, in some embodiments, the flowable liquid polymer can comprise an epoxy resin. At least a portion of the first thread layer can be impregnated before at least a portion of the second thread layer, and vice versa. The designations “first” and “second” do not imply an order of application of the flowable liquid polymer to a component.

In some embodiments, impregnating at least the portions of the first and second continuous threads with the flowable liquid polymer can comprise soaking the first and second thread layers in the flowable liquid polymer. In some embodiments, impregnating at least the portion of the first continuous thread with the flowable liquid polymer can completely embed individual thread lines of the first and/or second thread layers in the flowable liquid polymer.

In some embodiments, the thread lines of the first thread layer are not bonded to one another and the thread lines of the second thread layer are not bonded to one another before impregnating at least the portions of the first and second continuous threads with the flowable liquid polymer, respectively. In such embodiments, at least the portions of the first and second continuous threads can be impregnated with the flowable liquid polymer with the first and second continuous threads wrapped around the anchor points.

In some embodiments, the thread lines of the first thread layer can be at least partially bonded to one another and the thread lines of the second thread layer can be at least partially bonded to one another before impregnating at least the portions of the first and second continuous threads with the flowable liquid polymer, respectively. In such embodiments, the at least the portions of the first and second continuous threads can be impregnated with the flowable liquid polymer with the first and second continuous threads wrapped around the anchor points, or after the first and second thread layers are removed (for example, cut from) the anchor points. Bonding thread lines of the first thread layer before impregnating at least the portion of the first continuous thread with the flowable liquid polymer sets thread lines of the first thread layer in place so the first thread layer can be removed from the anchor points before impregnation. Similarly, bonding thread lines of the second thread layer before impregnating at least the portion of the second continuous thread with the flowable liquid polymer sets thread lines of the second thread layer in place so the second thread layer can be removed from the anchor points before impregnation.

For example, in some embodiments, at least one of the first continuous thread or the second continuous thread can comprise polymer thread (for example, thermoplastic polyurethane (TPU) thread) that can be heated to soften the polymer thread and partially bond the thread lines of the first and/or second thread layers. This partial bonding can serve to set the thread lines of the first and/or second thread layers in place while at least the portions of the first and/or second continuous threads are impregnated with the flowable liquid polymer (for example, by soaking at least a portion of the first and/or second thread layers with the flowable liquid polymer). Setting the thread lines in place can prevent unwanted reformation of the first and/or second thread layers during polymer impregnation and/or molding (for example, with mold 820) and maintain the desired directionality of thread lines during method 1000.

In some embodiments, the first thread layer and the second thread layer can be cut from the anchor points used to wind the first and second thread layers before impregnating at least the portions of the first and second continuous threads, respectively, with the flowable liquid polymer in step 1030. For example, the first thread layer and the second thread layer can be cut from the anchor points before being soaked with the flowable liquid polymer in step 1030.

In some embodiments, the first thread layer and the second thread layer are not cut from the anchor points used to wind the first and second thread layers before impregnating at least the portions of the first and second continuous threads, respectively, with the flowable liquid polymer in step 1030. For example, the first thread layer and the second thread layer can remain wound around the anchor points while being soaked with the flowable liquid polymer in step 1030.

In some embodiments, method 1000 can comprise positioning a third layer (for example, third layer 810) between the first and second thread layers in step 1040 to form a layered structure (for example, layered structure 600). In some embodiments, the third layer can be positioned between the first and second thread layers after impregnating at least the portion of the second continuous thread with the flowable liquid polymer. For example, in some embodiments, at least a portion of the second thread layer can be impregnated with the flowable liquid polymer and then the third layer can be positioned on top of the second thread layer (for example, as shown in FIG. 9). In some embodiments, the first thread layer can then be placed on top of the third layer and second thread layer, before or after at least a portion of the first thread layer has been impregnated with the flowable liquid polymer.

In some embodiments, the third layer can be positioned between the first and second layers before impregnating at least the portion of the first and second continuous threads with the flowable liquid polymer. In such embodiments, at least the portion of the first and second continuous threads can be impregnated with the flowable liquid polymer with the third layer positioned between the first and second thread layers.

In some embodiments, at least a portion of the third layer can be impregnated with the flowable liquid polymer. In some embodiments, the at least the portion of the third layer can be impregnated with the flowable liquid polymer before the third layer is positioned between the first and second thread layers. In some embodiments, none of the flowable liquid polymer is applied to the third layer before the third layer is positioned between the first and second thread layers.

In some embodiments, method 1000 can comprise conforming the layered structure to a shape of a mold (for example, mold 820) in step 1050. For example, in some embodiments, method 1000 can comprise confirming the layered structure to a mold comprising a shoe last.

In some embodiments, in step 1060, method 1000 can comprise positioning the mold and the layered structure inside a vacuum bag (for example, vacuum bag 830) and removing air from the vacuum bag. In some embodiments, the vacuum bag can surround the mold and the layered structure. The vacuum bag can form a seal around the mold and the layered structure such that removing air from the vacuum bag causes the vacuum bag to apply compression to the mold and the layered structure. Accordingly, removing air from the vacuum bag can bond the first and second thread layers and the third layer of the layered structure to one another via the flowable liquid polymer. While “the flowable liquid polymer” is referred to for clarity, it should be understood that at the time of positioning the mold and layered structure in the vacuum bag, the flowable liquid polymer may have partially set and its viscosity may have increased since the time it was used to impregnate at least the portion of the first and second continuous thread.

The steps of method 1000 can be used to form a layered structure 600 as shown in FIGS. 6-8 which can form at least a portion of an article of apparel (for example, article of apparel 100). When the flowable liquid polymer has dried (for example, as described with respect to FIG. 5), it can form a polymer matrix (for example, polymer matrix 812) bonding components of layered structure 600 together. This process is described with respect to FIG. 7.

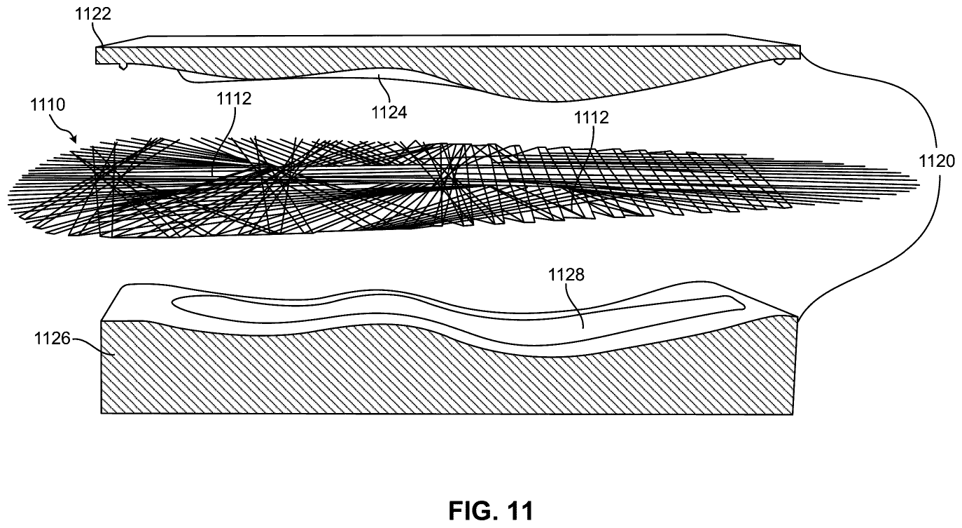

FIG. 11 shows a mold 1120 for bonding thread layer(s) 1110 to an additional component according to some embodiments. Thread layer(s) 1110 can comprise one or more thread layers as described herein (for example, one or more thread layers of thread layer(s) 122, 200, 220, and 240). Accordingly, thread layer(s) 1110 can comprise either a single thread layer or can comprise a thread pattern (for example, thread pattern 300). In some embodiments, at least a portion of thread layer(s) 1110 can have been impregnated with a flowable liquid polymer before, during, and/or after winding as described herein.

In some embodiments, thread layer(s) 1110 can be positioned between a first mold plate 1122 of mold 1120 and a second mold plate 1126 of mold 1120. First mold plate 1122 and/or second mold plate 1126 can comprise a cavity that receives a component (for example, plate 1210 shown in FIG. 12). For example, second mold plate 1126 can comprise cavity 1128 configured to receive at least a portion of thread layer(s) 1110 and/or the component. In some embodiments, the component can be bonded to thread layer(s) 1110 by the application of heat and/or pressure via mold 1120. The heat and/or pressure can serve to soften one or more of the component and thread lines 1112 of thread layer(s) 1110 to bond the thread lines 1112 of thread layer(s) 1110 to the component. In some embodiments, thread lines 1112 of thread layer(s) 1110 can be at least partially embedded in the component. In some embodiments, thread lines 1112 of thread layer(s) 1110 are not at least partially embedded in the component, but are bonded to a surface of the component via the at least partial melting and re-solidifying of the thread lines 1112 and/or via a bonding layer. In some embodiments, the bonding of thread lines 1112 of thread layer(s) 1110 to the component can be accomplished by at least partial melting of the thread lines 1112, the component, or both within the mold 1120. In such embodiments, the at least partial melting of the thread lines 1112 and/or component can fuse the thread lines 1112 to the component, and vice versa.

In some embodiments, the component can be bonded to thread layer(s) 1110 by injection molding. For example, in some embodiments, when first mold plate 1122 and second mold plate 1126 are joined, a cavity within the joined mold plates 1122, 1126 can be adjacent thread layer(s) 1110. A molten polymer material can then be injected into the cavity to bond the polymer to thread lines 1112 of the thread layer(s) 1110 and form the molten polymer material into a desired shape for the component (based on the cavity shape). In such embodiments, thread lines 1112 of thread layer(s) 1110 can be at least partially embedded within the polymer material.

While the use of mold 1120 is discussed, thread layer(s) 1110 can be bonded to an additional component using any number of methods, which do not necessarily require mold 1120. These methods can comprise one or more of the following techniques. (1) Applying an adhesive to thread layer(s) 1110 and/or the component. (2) IR heating the thread layer(s) 1110 and/or the component to soften or partially melt the materials of thread layer(s) 1110 and/or the component or to activate a thermally activated adhesive. (3) Impregnating at least a portion of continuous thread(s) of thread layer(s) 1110 with a flowable liquid polymer before, during, or after winding thread layer(s) 1110, as described herein with respect to FIGS. 5 and 10, and contacting impregnated thread layer(s) 1110 with the component. For example, thread layer(s) 1110 can be bonded to the additional component in the same way third layer 810 can be bonded to first thread layer(s) 710 and/or second thread layer(s) 720. (4) Attaching thread layer(s) 1110 to the component via one or more mechanical connections, for example, one or more crimps, rivets, screws, pins, etc.

FIG. 12 shows thread layer(s) 1110 bonded to a component in the form of a plate 1210 according to some embodiments. In some embodiments, plate 1210 can be a rigid plate, that is, it can comprise a material or structure that is more rigid than thread layer(s) 1110. In some embodiments, plate 1210 can be injection molded. In some embodiments, plate 1210 can be a sole plate of a footwear sole 1200, as shown in FIG. 12. In some embodiments, plate 1210 can define all or a portion of an outsole. In some embodiments, plate 1210 can define all or a portion of a midsole. In some embodiments, plate 1210 and thread layer(s) 1110 can, together, define all or a portion of an outsole, a midsole, or a combination thereof. For example, plate 1210 can form a base of the outsole and thread layer(s) 1110 can be overlaid on portions of a ground-facing surface of plate 1210, while other portions of the ground-facing surface of plate 1210 still contact the surface on which a wearer is walking while wearing a shoe incorporating sole 1200.

While a footwear sole 1200 is discussed, plate 1210 need not be part of a footwear sole. Plate 1210 can be any component that is more rigid than thread layer(s) 1110 to provide increased rigidity to a portion of any article of apparel. As a non-limiting example, plate 1210 can be a rigid component of protective sports equipment, for example, a shin guard or ankle brace.

As shown in FIG. 12, sole 1200 can comprise a perimeter edge 1202. Plate 1210 can comprise a perimeter edge 1211 and one or more openings 1212. An opening 1212 can comprise a perimeter edge 1214. In some embodiments, an opening 1212 can be an interior opening 1212a entirely surrounded by material of plate 1210 along a perimeter edge 1214a of the opening 1212a. In some embodiments, an opening 1212 can be an exterior opening 1212b partially surrounded by material of plate 1210 along a perimeter edge 1214b of the opening 1212b. The perimeter edge 1214 of such partially surrounded openings can partially overlap perimeter edge 1211 of plate 1210. Such partially surrounded openings can define a space between perimeter edge 1202 of sole 1200 and perimeter edge 1211 of plate 1210. Though plate 1210 shown in FIG. 12 can comprise multiple such openings 1212, as is shown in FIG. 12, only one such opening 1212b is defined for ease of reference.

An interior opening 1212a can comprise an empty space in plate 1210. In some embodiments, the area of all interior openings 1212a in plate 1210 (i.e., the sum of the areas defined by perimeter edges 1214a) can comprise a percentage of the surface area of plate 1210 (i.e., the surface area of one side of plate 1210, considering only solid portions of plate 1210). In some embodiments, the percentage can be in the range from 5% to 95%, including subranges. For example, in some embodiments, the percentage can be in the range from 10% to 90%, from 20% to 80%, from 30% to 70%, from 40% to 60%, or about 50%. In some embodiments, the percentage can vary depending on the relative or absolute rigidities of thread layer(s) 1110 and plate 1210. For example, in some embodiments, the percentage can be proportional to the rigidity of plate 1210 relative to thread layer(s) 1110. As the relative rigidity of plate 1210 increases, the percentage can increase. Additionally or alternatively, in some embodiments, the percentage can be proportional to the absolute rigidities or both plate 1210 and thread layer(s) 1110. As both the rigidities of plate 1210 and thread layer(s) 1110 increase, the percentage can increase.

In some embodiments, the number, size, and/or shape of openings 1212 can be selected to customize the characteristics of sole 1200, including flexibility. In some embodiments, the number, size, and/or shape of openings 1212 can be selected to match a foot force profile of a wearer, measured, for example, using sensors that detect the force applied by different regions of the wearer's foot during an athletic activity. In some embodiments, the number, size, and/or shape of openings 1212 can be selected depending on a type of shoe for which sole 1200 is designed (for example, a basketball shoe, a running shoe, a hiking shoe, a soccer shoe, a football shoe, etc.).

Thread layer(s) 1110 can each comprise a perimeter edge. In some embodiments, the perimeter edge of a thread layer 1110 can correspond to where the thread layer 1110 was cut before removal from anchor points (for example, anchor points 290). However, the thread layer 1110 need not be cut prior to removal from a support plate or structure used to wind the thread layer 1110. In cases in which thread layer(s) 1110 comprises more than one thread layer, in some embodiments, the perimeter edge of each thread layer 1110 can overlap one the perimeter edge(s) of other thread layer(s) 1110. In some embodiments, at least one thread layer 1110 can comprise a perimeter edge at least partially overlapping perimeter edge 1202 of sole 1200. In some embodiments, at least one thread layer 1110 can comprise a perimeter edge at least partially overlapping perimeter edge 1211 of plate 1210.

In some embodiments, one or more of thread layer(s) 1110 do not extend across a portion of an upper to which sole 1200 is attached. That is, in some embodiments, the perimeter edge of at least one thread layer(s) 1110 does not overlap the upper when sole 1200 is attached to the upper. In some embodiments, no perimeter edge of thread layer(s) 1110 overlaps the upper when sole 1200 is attached to the upper (i.e., thread layer(s) 1110 are contained within sole 1200).

In some embodiments, one or more of thread layer(s) 1110 can extend across a portion of an upper to which sole 1200 is attached. For example, in some embodiments, thread lines 1112 of thread layer(s) 1110 can extend from a medial side of an upper coupled to sole 1200, across sole 1200, and to a lateral side of the upper. In some embodiments, a plurality of thread lines 1112 of thread layer(s) 1110 extending from the medial side of the upper, across sole 1200, and to the lateral side of the upper can be continuous thread lines. In some embodiments, thread lines 1112 that extend from the medial side of the upper, across sole 1200, and to the lateral side of the upper can be directly or indirectly coupled to the sides of the upper. For example, the thread lines 1112 can be stitched or directly bonded to the sides of the upper.

In some embodiments, thread lines 1112 of thread layer(s) 1110 can extend from a forefoot end of the upper coupled to sole 1200, across sole 1200, and to a heel end of the upper. In some embodiments, a plurality of thread lines 1112 of thread layer(s) 1110 extending from the forefoot end of the upper, across sole 1200, and to the heel end of the upper can be continuous thread lines. In some embodiments, thread lines 1112 that extend from the forefoot end of the upper, across sole 1200, and to the heel end of the upper can be directly or indirectly coupled to the forefoot end and the heel end of the upper. For example, the thread lines 1112 can be stitched or directly bonded to the forefoot end and the heel end of the upper.

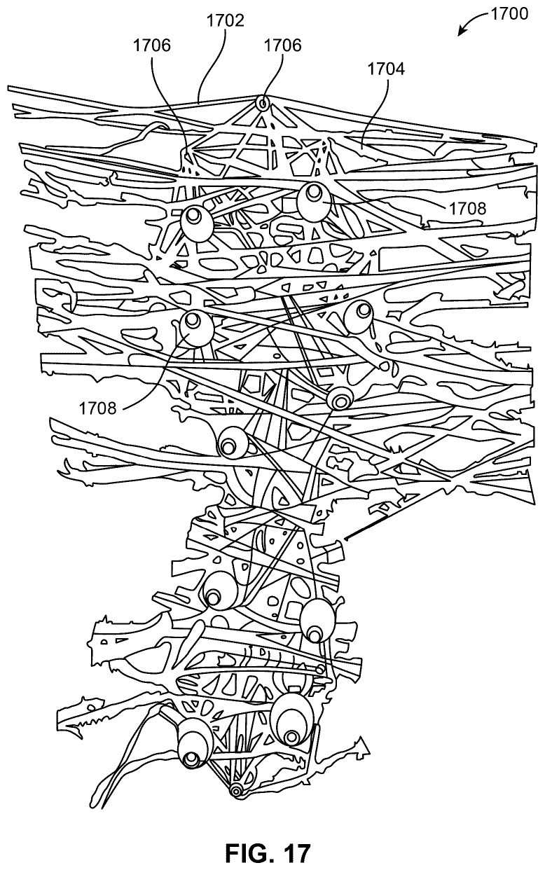

In some embodiments, thread lines 1112 extending across sole 1200 can partially form an outsole (for example, plate 1210 can be a component of the outsole). In such embodiments, thread lines 1112 can extend across a side of plate 1210 distal a wearer's foot when worn. In some of such embodiments, thread layer(s) 1110 can comprise ground-contacting structures (for example, structures 1708 described with respect to FIG. 17, which can be traction elements). In some embodiments, thread lines 1112 extending through sole 1200 can extend through an interface between a midsole and an outsole (for example, on the side of plate 1210 adjacent a wearer's foot when worn).

As shown in FIG. 12, thread lines 1112 can extend continuously from a first side of a perimeter edge of thread layer(s) 1110 to a second side of a perimeter edge of thread layer(s) 1110. Additionally, thread layer(s) 1110 can be bonded to plate 1210 such that one or more thread lines 1112 extend across an opening 1212. For example, as shown in FIG. 12, one or more thread lines 1112 can extend across an opening 1212. In some embodiments, plate 1210 can comprise a plurality of openings (for example, two or more interior openings 1212a). In such embodiments, one or more thread lines 1112 can extend across the plurality of openings. When multiple thread lines 1112 extend across an opening 1212, the multiple thread lines 1112 can be separated by empty space 1220 within the opening, as shown in FIG. 12.

In some embodiments, thread lines 1112 can be bonded to each other using any of the methods described herein for bonding thread lines to one another, for example, at intersection points between thread lines. In some embodiments, thread lines 1112 can be bonded to each other before thread layer(s) 1110 is/are bonded to plate 1210.

While sole 1200 is shown in FIG. 12 as comprising only thread layer(s) 1110 and plate 1210 for simplicity, in some embodiments, sole 1200 can comprise other components of a shoe sole, as is understood in the art. For example, in embodiments in which thread layer(s) 1110 and plate 1210 at least partially form a midsole and/or an outsole, sole 1200 can comprise an insole coupled to thread layer(s) 1110 and plate 1210.

FIG. 13 illustrates a method of bonding thread lines 1112 to each other according to some embodiments. As shown in FIG. 13, in some embodiments, a bonding sheet 1302 can be applied to thread layer(s) 1110. In some embodiments bonding sheet 1302 can be a polymeric sheet comprising a polymeric material that can be melted. In some embodiments, heat and/or pressure can be applied to bonding sheet 1302 to at least partially melt bonding sheet 1302 and at least partially embed thread lines 1112 in the material of bonding sheet 1302. Accordingly, thread lines 1112 can be bonded to each other by being jointly bonded to bonding sheet 1302. In some embodiments, bonding sheet 1302 can comprise thermoplastic polyurethane (TPU). In some embodiments, the bonding sheet 1302 can comprise optically transparent TPU.

In some embodiments, after thread lines 1112 are initially bonded to bonding sheet 1302, one or more thread lines 1112 can be impregnated with a flowable liquid polymer as discussed herein. In some embodiments, this can serve to further bond thread lines 1112 to one another and further stiffen the resulting combination of bonding sheet 1302 and thread layer(s) 1110.

While described for bonding thread lines 1112 of thread layer(s) 1110 that will be bonded to plate 1210, the application of bonding sheet 1302 can be used to bond thread lines of any thread layer described herein (for example, thread layers 122, 200, 220, 240, 710, 720, or 1510).

In some embodiments, bonding sheet 1302 need not be used. In such embodiments, thread lines 1112 of thread layer(s) 1110 can be bonded to one another by impregnating at least a portion of thread layer(s) 1110 with a flowable liquid polymer before, during, or after winding as described herein, and applying heat and/or pressure using a vacuum bag, heat press, or mold positioned within an autoclave.

FIG. 14 shows an exemplary heat press 1400 for bonding continuous thread(s) of a thread layer or thread pattern at locations of anchor points and/or intersection points between thread lines. Heat press 1400 can apply pressure and heat to one or more thread layers (for example, thread layer(s) 122, 200, 220, 240, 710, 720, 1110, or 1510) to bond continuous thread(s) of a thread layer or thread pattern at locations of anchor points and/or intersection points between thread lines. Additionally, in some embodiments, heat press 1400 can apply pressure and heat to a thread layer or thread pattern, at least a portion of which has been impregnated with a flowable liquid polymer according to any of the methods described herein. Heat and pressure applied by heat press 1400 can cure the flowable liquid polymer and/or provide the thread layer or thread pattern with a finished surface.

In some embodiments, heat press 1400 can provide heat at a predetermined temperature equal to or above the melting point of polymeric material(s) of polymer thread(s) of a thread layer or thread pattern. In some embodiments, heat press 1400 can provide heat at a predetermined temperature below the melting point of polymeric material(s) of polymer thread(s) of a thread layer or thread pattern, but high enough to cause the polymeric material(s) to bond (fuse) together, or to other materials of the thread layer or thread pattern.

The temperature used to bond continuous thread(s) of a thread layer or thread pattern with heat press 1400 can be 180 degrees C. or less. In some embodiments, the predetermined temperature can be in the range of 180 degrees C. to 80 degrees C. In some embodiments, the predetermined temperature can be 160 degrees C. or less. In some embodiments, the predetermined temperature can be in the range of 160 degrees C. to 65 degrees C. In some embodiments, the predetermined temperature can be such that polymeric material(s) of polymer thread(s) of a thread layer or thread pattern undergo no chemical reactions during heating.

Heat can be applied to a thread layer or thread pattern in heat press 1400 in one or more ways, such as but not limited to, radio frequency heat sealing (welding), high frequency heat sealing (welding), infra-red welding, and steaming. Heat transfer between a thread layer or thread pattern and heat press 1400 can be via conduction and/or convection. In some embodiments, heat can be applied to a single outer surface of a thread layer or thread pattern in heat press 1400. In some embodiments, heat can be applied to both outer surfaces of a thread layer or thread pattern in heat press 1400. In some embodiments, heat can be applied to a bonding sheet (for example, sheet 1302) disposed in contact with a thread layer or thread pattern in heat press 1400, optionally with non-stick sheet(s) disposed in between surfaces of heat press 1400 and the bonding sheet.

In some embodiments, an interior surface of heat press 1400 can comprise one or more cavities and/or protrusions configured to mold a thread layer or thread pattern to a particular shape. For example, first mold plate 1122 and second mold plate 1126 can be positioned inside heat press 1400 to conform thread layer(s) 1110 to the shape of plate 1210.

In some embodiments, after applying heat and pressure to a thread layer or thread pattern in heat press 1400, the thread layer or thread pattern can be removed from heat press 1400 to cool. In some embodiments, after applying heat and pressure to the thread layer or thread pattern in heat press 1400, the thread layer or thread pattern can be removed from heat press 1400 and placed in a cold press to cool. In some embodiments, after applying heat and pressure to the thread layer or thread pattern in heat press 1400, the thread layer or thread pattern can be cooled while the thread layer or thread pattern remains within heat press 1400. In some embodiments, heat press 1400 can be cooled while the thread layer or thread pattern remains within heat press 1400, thereby cooling the thread layer or thread pattern.

In some embodiments, after heat pressing a thread layer or thread pattern, excess material can be removed (for example, cut) from the thread layer or thread pattern to define the edges of the resulting material (for example, thread border(s) 250). In some embodiments, excess material can be removed after cooling the thread layer or thread pattern. In some embodiments, edges of a thread layer or thread pattern bonded in heat press 1400 can be folded and/or sown at a seam to define edges of a portion of an article of apparel.

While FIG. 14 shows a standalone heat press 1400, in some embodiments, applying heat and pressure to a thread layer or thread pattern (for example, thread layer(s) 1110) can comprise placing the thread layer or thread pattern within a two-sided mold (for example, mold 1120), placing the mold in an autoclave, and applying heat and pressure using the autoclave.

In some embodiments, continuous thread(s) of a thread layer or thread pattern can be bonded by pressing a thread layer or thread pattern against the outer surface of an object (for example, mold 820) configured to provide a desired shape to the thread layer or thread pattern and heating the thread layer or thread pattern to impart the desired shape. In some embodiments, the object can be a last.

In some embodiments, before being bonded to an additional component (for example, plate 1210) a thread layer or thread pattern can be wound around anchor points to conform to the shape of a portion of an article of apparel comprising the additional component. As a non-limiting example, in some embodiments, a thread layer or thread pattern can be wound around anchor points to define cleats for sole 1200 before being bonded to plate 1210. As another example, a thread layer or thread pattern can be wound around anchor points to define a support member for sole 1200 before being bonded to plate 1210. Exemplary support members include, but are not limited to, torsion plates or stiffening plates. In some embodiments, support members defined by a thread layer or thread pattern can extend between cleats defined by a thread layer or thread pattern. As an additional or alternative example, a thread layer or thread pattern can be wound around anchor points to define an outsole or a portion of an outsole before being bonded to plate 1210.

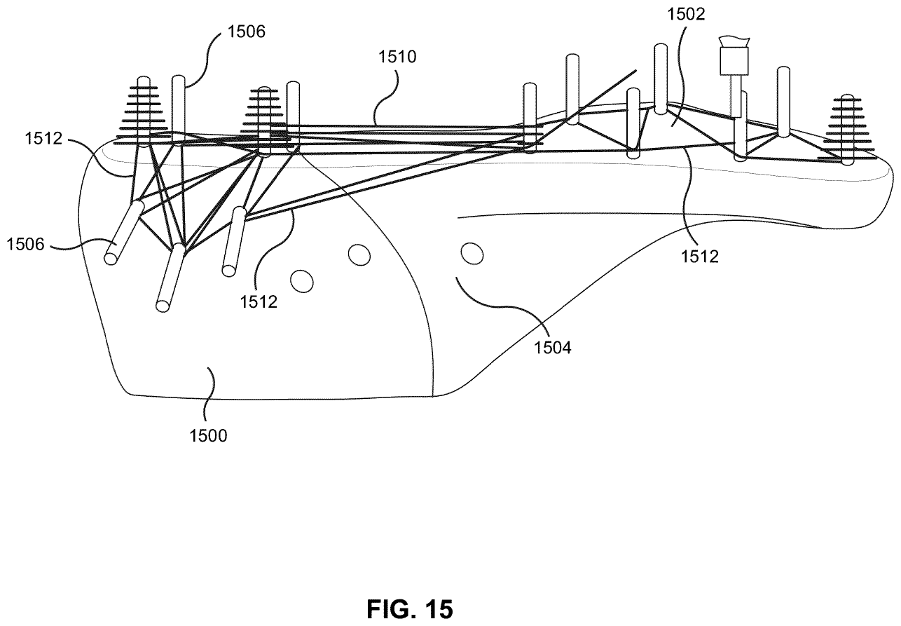

FIG. 15 shows a three-dimensional object 1500 that can serve the same or similar function as support plate 402 according to some embodiments. For example, three-dimensional object 1500 can be configured for winding a thread layer or thread pattern around anchor points 1506 to conform to the shape of at least a portion of an article of apparel, for example, at least a sole portion of a shoe. In some embodiments, three-dimensional object 1500 can be a last, though three-dimensional object 1500 need not be a complete last. For example, it can be a portion of a last such as a sole or other portion.

Three-dimensional object 1500 can comprise a sole surface 1502 and an upper surface 1504. Sole surface 1502 can comprise anchor points 1506 for winding thread lines 1512 of a thread layer(s) 1510 to conform to the shape of a shoe sole. In some embodiments, upper surface 1504 can comprise anchor points 1506 for winding thread lines 1512 of thread layer(s) 1510 to conform to the shape of a shoe upper. However, in some embodiments, three-dimensional object 1500 does not comprise anchor points 1506 on upper surface 1504.

In some embodiments, three-dimensional object 1500 can be used to simultaneously wind thread layer(s) 1510 that define(s) a portion of a sole and a portion of an upper for an article of footwear. In such embodiments, thread layer(s) 1510 can comprise a plurality of thread lines extending from a sole feature (for example, a cleat or support member) to an upper.

Thread lines 1512 of thread layer(s) 1510 can be bonded to each other at anchor points 1506 and/or intersection points as described herein. Thread layer(s) 1510 can be removed from object 1500 before or after bonding thread lines 1512. In some embodiments, thread lines 1512 of thread layer(s) 1510 can be bonded to each other at anchor points 1506 and/or intersection points while thread layer(s) 1510 is disposed on object 1500. In some embodiments, thread lines 1512 of thread layer(s) 1510 can be bonded to each other at anchor points 1506 and/or intersection points after thread layer(s) 1510 is removed from three-dimensional object 1500.

In some embodiments, thread layer(s) 1510 can be removed from anchor points 1506 when thread layer(s) 1510 are removed from three-dimensional object 1500. In some embodiments, anchor points 1506 can be incorporated into thread layer(s) 1510 and define a portion of thread layer(s) 1510 after thread layer(s) 1510 is bonded. For example, removable anchor points 1506 can be bonded to thread layer(s) 1510 and removed from object 1500 when thread layer(s) 1510 is removed from object 1500. One example of this is when anchor points are posts for a forming a cleat. In such embodiments, thread lines 1512 can be wound around the posts. Then, when bonding the thread lines 1512 at the posts, posts the posts are also bonded to thread lines 1512. In some embodiments, the posts can be directly bonded to thread lines 1512, for example, via a polymeric material of thread lines 1512 and/or the posts.

Once thread layer(s) 1510 are removed from object 1500, thread layer(s) 1510 can then be bonded to plate 1210 as described for thread layer(s) 1110 and plate 1210.

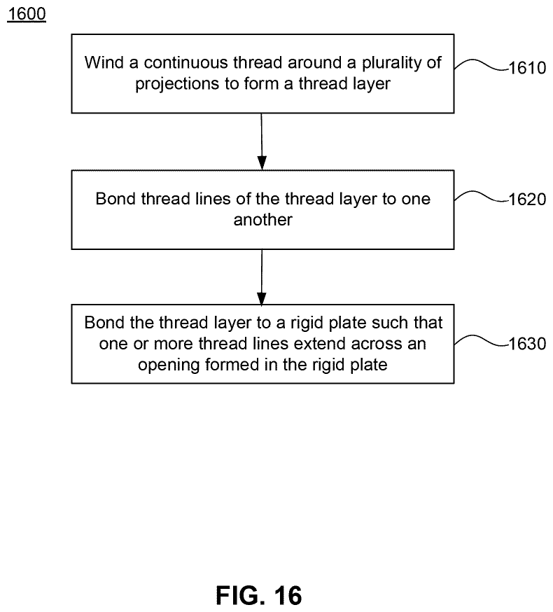

FIG. 16 shows a method 1600 of making an article of apparel (for example, article of apparel 100) according to some embodiments.

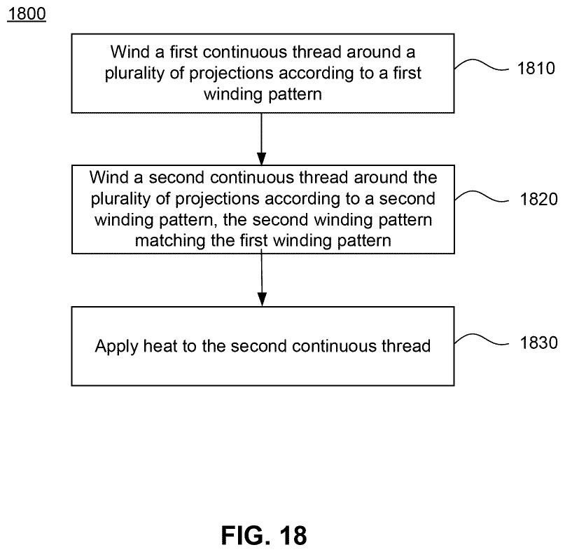

Unless stated otherwise, the steps of method 1600 need not be performed in the order set forth herein. Additionally, unless specified otherwise, the steps of method 1600 need not be performed sequentially. The steps can be performed in a different order or simultaneously. As one example, step 1620 of method 1600 need not be performed after step 1610. Rather, step 1620 can be performed simultaneously with step 1610, for example, if the thread layer of method 1600 is formed using method 500 shown in FIG. 5. As another example, step 1630 need not be performed after steps 1610 and 1620. Rather, step 1630 can be performed simultaneously with steps 1610 and/or 1620, for example, if the thread layer of method 1600 is formed using method 500 shown in FIG. 5 while the continuous thread of method 1600 is in contact with the rigid plate of method 1600. Additionally, step 1630 can be performed simultaneously with step 1620 if step 1620 is performed as described with respect to FIGS. 17-18 while the thread layer of method 1600 is in contact with the rigid plate of method 1600.

Steps of method 1600 can overlap with steps of method 500 and/or method 1000. For example, in some embodiments, steps of method 500 related to winding a first continuous thread and impregnating at least a portion of the first continuous thread with a flowable liquid polymer can serve to perform at least steps 1610 and 1620 of method 1600. Further, in some embodiments, the step of impregnating at least a portion of the first continuous thread with a flowable liquid polymer can serve to perform step 1630 if the first continuous thread is wound while in contact with the rigid plate of step 1630.

Step 1610 comprises winding a continuous thread around a plurality of projections (for example, anchor points 290, which can be projections) to form a thread layer (for example, a thread layer of thread layer(s) 1110) comprising a plurality of thread lines (for example, thread lines 1112). As described herein, each thread line can extend between two respective projections, either before the thread layer is removed from (for example cut from) the plurality of projections, or if the thread layer remains coupled to the plurality of projections and they are removed from a support structure (for example, support plate 402) with the thread layer.

Step 1620 comprises bonding thread lines (for example, thread lines 1112) of the thread layer to one another. In some embodiments, the thread lines can be bonded at points of intersection between the thread lines using any suitable method described herein. For example, the thread lines can be bonded via an adhesive, a bonding layer, thermal (conductive or convective) heat (for example, in a heat press or oven), IR (infrared) heating, laser heating, microwave heating, steam, a mechanical fastener (for example, a clip), hook and loop fasters, needle-punching, hydro-entanglement, ultrasonic/vibratory entanglement, felting, knotting, chemical bonding with a catalyst of biomaterial, adhesive spraying (for example, CNC adhesive spray deposition), or by pushing one thread line through the other thread line(s). In some embodiments, the thread lines can be directly bonded at points of intersection between the thread lines.

In some embodiments, bonding the thread lines of the thread layer to one another in step 1620 can comprise applying a polymeric sheet (for example, bonding sheet 1302) to the thread layer. In some embodiments, bonding the thread lines of the thread layer to one another in step 1620 can comprise heating the polymeric sheet to at least partially melt the polymeric sheet.

In some embodiments, method 1600 can comprise multiple winding steps 1610 and/or multiple bonding steps 1620. For example, a first thread layer can be wound in a first winding step 1610 and then thread lines of the first layer can be bonded in a first bonding step 1620. Then a second thread layer can be wound in a second winding step 1610 and thread lines of the second thread layer can be bonded in a second bonding step 1620. As another example, a first thread layer can be wound in a first winding step 1610 and a second thread layer can be wound in a second winding step 1610. Then, after the first and second winding steps, a bonding step 1620 can be performed to bond thread lines of the first and second thread layers.

In some embodiments, bonding step 1620 can comprise a preliminary bonding step to hold the pattern of one or more thread layers until a final bonding step is performed. For example, a preliminary bonding step can allow a thread layer to be removed from anchor points and/or placed in a mold (for example, mold 1120). Then thread lines of the thread layer can be finally bonded to one another and/or an additional component. In some embodiments, the preliminary bonding step can comprise softening a polymeric material of the thread lines by applying heat and/or pressure such that one or more thread lines are preliminarily bonded to one another to maintain the shape of the thread layer. In some embodiments, the preliminary bonding step can comprise applying a bonding sheet (for example, bonding sheet 1302) to the thread lines and applying heat and/or pressure to the bonding sheet such that one or more thread lines are preliminarily bonded to one another to maintain the shape of the thread layer. In some embodiments, the final bonding step can comprise impregnating at least a portion of the thread layer with a flowable liquid polymer, as described herein.

Step 1630 comprises bonding the thread layer to a rigid plate such that one or more thread lines of the thread layer extend across an opening (for example, an opening 1212) formed in the rigid plate. In some embodiments, the thread layer can be bound to the rigid plate after bonding the thread lines of the thread layer to one another in step 1620. As noted herein, in some embodiments, the thread layer can be bound to the rigid plate while bonding the thread lines of the thread layer to one another in step 1620.

Bonding of the thread layer to the rigid plate can be performed in a variety of ways, including one or more of the methods for bonding thread layer(s) 1110 to an additional component discussed and enumerated with respect to FIG. 11.

After the thread layer is bonded to the rigid plate, the thread layer and rigid plate can be coupled to other portions of an article of apparel. For example, in some embodiments, the thread layer and rigid plate can form at least a portion of a shoe sole (for example, sole 1200) and can be coupled to other portions of the shoe sole and/or a shoe upper.

FIGS. 17 and 18 illustrate a method of making an article of apparel (for example, article of apparel 100) according to some embodiments.

FIG. 17 shows a first continuous thread 1702 and a second continuous thread 1704 wound according to matching winding patterns. As used herein, “winding pattern” can refer to the path a continuous thread follows while being would around a plurality of anchor points (for example, anchor points 1706, which can be located where projections contacted the first and second continuous threads 1702, 1704 during winding). The path a continuous thread follows can comprise an order of projections around which the continuous thread is wound. In addition, the path a continuous thread follows can comprise a direction in which the continuous thread is wound (clockwise or counterclockwise) around a projection, for each projection.

As used herein, “matching” winding patterns can refer to winding patterns in which a second order of projections around which second continuous thread 1704 is wound is either the same as or an inverse of a first order of projections around which first continuous thread 1702 is wound. As a non-limiting example, if projections 1, 2, and 3 are used to wind first continuous thread 1702, and first continuous thread is wound around projections 1, 2, and 3 in that order, a matching winding pattern would comprise winding second continuous thread 1704 around projections 1, 2, and 3 in that order or winding second continuous thread around projections 3, 2, and 1 in that order.

In some embodiments, “matching” winding patterns can additionally refer to winding patterns in which the directions in which second continuous thread 1704 is wound around projections are either the same as or an inverse of the directions in which the first continuous thread 1702 is wound around the projections, depending on whether the order of projections around which the first and second continuous threads 1702, 1704 are wound are the same or inverse of one another. As a non-limiting example, if projections 1, 2, and 3 are used to wind first continuous thread 1702, and first continuous thread is wound around projections 1 (clockwise), 2 (counterclockwise), and 3 (clockwise) in that order and directions, a matching winding pattern can comprise winding second continuous thread 1704 around projections 1 (clockwise), 2 (counterclockwise), and 3 (clockwise) in that order and in the same directions or winding second continuous thread around projections 3 (counterclockwise), 2 (clockwise), and 1 (counterclockwise) in that order and in inverse directions, as parenthetically noted.

Matching projection orders and/or directions followed during winding can result in second continuous thread 1704 overlaying first continuous thread 1702 along at least a portion of first continuous thread 1702. In some embodiments, second continuous thread 1704 can be wound over first continuous thread 1702 on the projections that define anchor points 1706. In some embodiments, second continuous thread 1704 can be wound under first continuous thread 1702 on the projections that define anchor points 1706. In some embodiments, second continuous thread 1704 can be wound to the side of first continuous thread 1702 on the projections that define anchor points 1706.

In some embodiments, second continuous thread 1704 can abut first continuous thread 1702 along at least a portion of first continuous thread 1702. In some embodiments, second continuous thread 1704 can abut and overlap at least a portion of first continuous thread 1702. In some embodiments, second continuous thread 1704 can abut first continuous thread 1702 along at least a portion of first continuous thread 1702 but not overlap at least the portion of first continuous thread 1702. For example, in some embodiments, second continuous thread 1704 can abut at least a portion of first continuous thread 1702 and be positioned to the side of at least the portion of first continuous thread 1702.

In some embodiments, second continuous thread 1704 need not necessarily directly abut at least a portion of first continuous thread 1702. In some embodiments, second continuous thread 1704 can be configured such that material of second continuous thread 1704 contacts first continuous thread 1702 when second continuous thread 1704 is at least partially melted. In some embodiments, this can mean second continuous thread 1704 is positioned above first continuous thread 1702 (no matter its initial winding orientation or position), as defined relative to the gravity vector, when second continuous thread 1704 is being at least partially melted, as gravity can aid material of second continuous thread 1704 contacting first continuous thread 1702.

The winding patterns of first continuous thread 1702 and second continuous thread 1704 need not match along the entire lengths of wound first and second continuous threads 1702, 1704.

FIG. 17 shows a thread pattern 1700 after it has been removed from projections used to wind the thread pattern and after second continuous thread 1704 has been at least partially melted. The thread pattern 1700 comprises the first continuous thread 1702 and the second continuous thread 1704. The first continuous thread 1702 can comprise a first material. The second continuous thread 1704 can comprise a second material. In some embodiments, the second material can have a melting point lower than that of the first material. Accordingly, heat can be applied to second continuous thread 1704 and first continuous thread 1702 and only second continuous thread 1704 will at least partially melt. Second continuous thread 1704 at least partially melting can serve to bond thread lines formed from first continuous thread 1702 to one another and/or to an additional component (for example, plate 1210).

In some embodiments, the melting point of the second material can be at least 10° C. less than the melting point of the first material, at least 25° C. less than the melting point of the first material, at least 50° C. less than the melting point of the first material, or at least 100° C. less than the melting point of the first material. In some embodiments, the melting point of the second material can be in the range from 10% to 90% of the melting point of the first material, including subranges. For example, in some embodiments, the melting point of the second material can be in the range from 10% to 90% of the melting point of the first material, from 20% to 90% of the melting point of the first material, from 30% to 90% of the melting point of the first material, from 40% to 80% of the melting point of the first material, from 50% to 70% of the melting point of the first material, or about 60% of the melting point of the first material.

As shown in FIG. 17, in some embodiments, thread pattern 1700 can include structures 1708. In some embodiments, structures 1708 can be traction elements, for example, studs for the sole of a cleat. In some embodiments, structures 1708 can be ribs for additional stiffness. Structures 1708 can be formed by repeated winding of one or more of first and second continuous threads 1702, 1704 around a single projection defining an anchor point 1706 (for example, to form a stud), or repeated winding of one or more of first and second continuous threads 1702, 1704 between two or more projections defining anchor points 1706 (for example, to form a rib).

As shown in FIG. 17, thread pattern 1700 can be a portion of footwear. For example, thread pattern 1700 can be configured as a portion of a sole or an upper of a shoe. However, a thread pattern 1700 formed according to the method 1800 of FIG. 18 can be implemented in any article of apparel.

FIG. 18 shows a method of making an article of apparel (for example, article of apparel 100) according to some embodiments.

Unless stated otherwise, the steps of method 1800 need not be performed in the order set forth herein. Additionally, unless specified otherwise, the steps of method 1800 need not be performed sequentially. The steps can be performed in a different order or simultaneously. As one example, step 1820 of method 1800 need not be performed after step 1810. Rather, step 1820 can be performed simultaneously with step 1810, for example, if the first and second continuous threads of steps 1810-1820 are wound simultaneously using a CNC machine that implements simultaneous winding through a single or multiple thread guides, as disclosed in U.S. patents application Ser. No. 18/400,574 (CIRCULAR WINDING APPARATUS AND METHOD) and Ser. No. 18/400,620 (ROTATIONAL WINDING APPARATUS AND METHOD).

Steps of method 1800 can overlap with steps of method 500, method 1000, and/or method 1600. For example, in some embodiments, steps of method 1000 related to winding a first and second continuous thread can in some embodiments serve to perform at least steps 1810 and 1820 of method 1800. Additionally steps 1810-1830 of method 1800 can serve to perform at least steps 1610 and 1620 of method 1600.

Step 1810 comprises winding a first continuous thread (for example, first continuous thread 1702) comprising a first material around a plurality of projections (for example, projections defining anchor points 1706) according to a first winding pattern. Winding the first continuous thread around the plurality of projections can form a first thread layer comprising thread lines.

Step 1820 comprises winding a second continuous thread comprising a second material (for example, second continuous thread 1704) around the plurality of projections according to a second winding pattern. The plurality of projections can be the same plurality of projections around which the first continuous thread is wound. Winding the second continuous thread around the plurality of projections can form a second thread layer. In some embodiments, the second material can have a melting point lower than that of the first material. In some embodiments, the second winding pattern can match the first winding pattern.

In some embodiments, the first winding pattern can comprise a first order of projections around which the first continuous thread is wound. In some embodiments, the second winding pattern can comprise a second order of projections around which the second continuous thread is wound. In some embodiments, the second order can be either the same as the first order or an inverse of the first order.

In some embodiments, method 1800 can comprise multiple iterations of steps 1810 and 1820. Accordingly, in some embodiments, a thread pattern (for example, thread pattern 1700) comprising more than one pair of first and second continuous threads can be formed. Additionally, in some embodiments, method 1800 can comprise multiple iterations of step 1810. Accordingly, in some embodiments, a thread pattern (for example, thread pattern 1700) comprising more than one first continuous threads paired with a single low-melting point second continuous thread can be formed.

Step 1830 comprises applying heat to the second continuous thread. In some embodiments, applying heat to the second continuous thread can at least partially melt the second continuous thread to bond the thread lines of the first thread layer to one another. In some embodiments, the thread lines of the first thread layer can be bonded to one another by embedding the thread lines of the first thread layer within the second material. Heat can be applied to the second continuous thread according to any method disclosed herein, for example, thermal (conductive or convective) heating (for example, in a heat press such as heat press 1400 or an oven), IR (infrared) heating, laser heating, microwave heating, steaming, etc. In some embodiments, the heat can be applied to the second continuous thread while the first thread layer and the second thread layer are attached to the plurality of projections.

While various embodiments have been discussed herein in the context of footwear, other articles of apparel can be manufactured using the methods discussed herein. Other articles of apparel include, but are not limited to, a strobel board, a sock liner, pants, shorts, leggings, a sock, a jacket, a coat, a hat, a sleeve, a sweater, a shirt, a jersey, a bra, a bootie, and a glove. In some embodiments, when making these articles of apparel, and others, a thread layer or thread pattern can be wound around anchor points to form a thread layer or thread pattern defining all of a portion of these articles. In some embodiments, when making these articles of apparel, and others, a thread layer or thread pattern can be wound around anchor points to form a thread layer or thread pattern as discussed herein and all or a portion of these articles can be cut from the thread layer or thread pattern. For example, a strobel board can be cut from a thread layer or thread pattern.

One or more aspects of the methods of manufacturing an article of footwear discussed herein, or any part(s) or function(s) thereof (for example, defining a boundary line and winding continuous threads with a CNC machine), can be implemented using hardware, software modules, firmware, tangible computer readable media having instructions stored thereon, or a combination thereof and can be implemented in one or more computer systems or other processing systems.

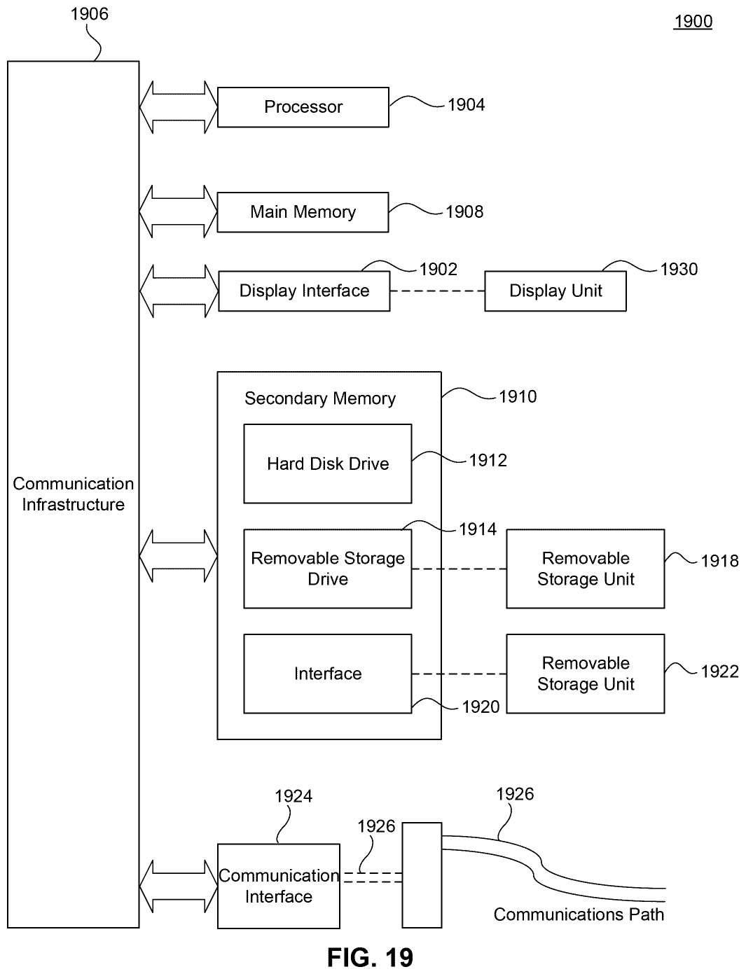

FIG. 19 shows an exemplary computer system 1900 by which embodiments, or portions thereof, can be implemented as computer-readable code, according to some embodiments. For example, aspects of the methods discussed herein can be implemented by computer system 1900 using hardware, software, firmware, tangible computer readable media having instructions stored thereon, or a combination thereof and can be implemented by one or more computer systems or other processing systems.

If programmable logic is used, such logic can execute on a commercially available processing platform or a special purpose device. One of ordinary skill in the art can appreciate that embodiments of the disclosed subject matter can be practiced with various computer system configurations, including multi-core multiprocessor systems, minicomputers, and mainframe computers, computer linked or clustered with distributed functions, as well as pervasive or miniature computers that can be embedded into virtually any device.

For instance, at least one processor device and a memory can be used to implement the above-described embodiments. A processor device can be a single processor, a plurality of processors, or combinations thereof. Processor devices can have one or more processor “cores.”

Various embodiments described herein can be implemented in terms of this example computer system 1900. After reading this description, it will become apparent to a person skilled in the relevant art how to implement one or more of the embodiments using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 1904 can be a special purpose or a general-purpose processor device. As will be appreciated by persons skilled in the relevant art, processor device 1904 can also be a single processor in a multi-core/multiprocessor system, such system operating alone, or in a cluster of computing devices operating in a cluster or server farm. Processor device 1904 is connected to a communication infrastructure 1906, for example, a bus, message queue, network, or multi-core message-passing scheme.

Computer system 1900 also comprises a main memory 1908, for example, random access memory (RAM), and can also comprise a secondary memory 1910. Secondary memory 1910 can comprise, for example, a hard disk drive 1912, or removable storage drive 1914. Removable storage drive 1914 can comprise a floppy disk drive, a magnetic tape drive, an optical disk drive, a flash memory, a Universal Serial Bus (USB) drive, or the like. The removable storage drive 1914 reads from and/or writes to a removable storage unit 1918 in a well-known manner. Removable storage unit 1918 can comprise a floppy disk, magnetic tape, optical disk, etc. which is read by and written to by removable storage drive 1914. As will be appreciated by persons skilled in the relevant art, removable storage unit 1918 comprises a computer usable storage medium having stored therein computer software and/or data.

Computer system 1900 (optionally) comprises a display interface 1902 (which can comprise input and output devices such as keyboards, mice, etc.) that forwards graphics, text, and other data from communication infrastructure 1906 (or from a frame buffer not shown) for display on display unit 1930.

In additional and/or alternative implementations, secondary memory 1910 can comprise other similar means for allowing computer programs or other instructions to be loaded into computer system 1900. Such means can comprise, for example, a removable storage unit 1922 and an interface 1920. Examples of such means can comprise a program cartridge and cartridge interface (such as that found in video game devices), a removable memory chip (such as an EPROM, or PROM) and associated socket, and other removable storage units 1922 and interfaces 1920 which allow software and data to be transferred from the removable storage unit 1922 to computer system 1900.

Computer system 1900 can also comprise a communication interface 1924. Communication interface 1924 allows software and data to be transferred between computer system 1900 and external devices. Communication interface 1924 can comprise a modem, a network interface (such as an Ethernet card), a communication port, a PCMCIA slot and card, or the like. Software and data transferred via communication interface 1924 can be in the form of signals, which can be electronic, electromagnetic, optical, or other signals capable of being received by communication interface 1924. These signals can be provided to communication interface 1924 via a communication path 1926. Communication path 1926 carries signals and can be implemented using wire or cable, fiber optics, a phone line, a cellular phone link, an RF link or other communication channels.

In this document, the terms “computer program medium” and “computer usable medium” are used to generally refer to media such as removable storage unit 1918, removable storage unit 1922, and a hard disk installed in hard disk drive 1912. Computer program medium and computer usable medium can also refer to memories, such as main memory 1908 and secondary memory 1910, which can be memory semiconductors (for example, DRAMs, etc.).

Computer programs (also called computer control logic) are stored in main memory 1908 and/or secondary memory 1910. Computer programs can also be received via communication interface 1924. Such computer programs, when executed, enable computer system 1900 to implement the embodiments as discussed herein. In particular, the computer programs, when executed, enable processor device 1904 to implement the processes of the embodiments discussed here. Accordingly, such computer programs represent controllers of the computer system 1900. Where the embodiments are implemented using software, the software can be stored in a computer program product and loaded into computer system 1900 using removable storage drive 1914, interface 1920, and hard disk drive 1912, or communication interface 1924.

Embodiments described herein also can be directed to computer program products comprising software stored on any computer useable medium. Such software, when executed in one or more data processing device, causes a data processing device(s) to operate as described herein. Embodiments described herein can employ any computer useable or readable medium. Examples of computer useable mediums comprise, but are not limited to, primary storage devices (for example, any type of random access memory), secondary storage devices (for example, hard drives, floppy disks, CD ROMS, ZIP disks, tapes, magnetic storage devices, and optical storage devices, MEMS, nanotechnological storage device, etc.).

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but can be interchanged to meet various situations as would be appreciated by one of skill in the art.

Where a range of numerical values comprising upper and lower values is recited herein, unless otherwise stated in specific circumstances, the range is intended to include the endpoints thereof, and all integers and fractions within the range. It is not intended that the disclosure or claims be limited to the specific values recited when defining a range. Further, when an amount, concentration, or other value or parameter is given as a range, one or more ranges, or as list of upper values and lower values, this is to be understood as specifically disclosing all ranges formed from any pair of any upper range limit or value and any lower range limit or value, regardless of whether such pairs are separately disclosed.

The foregoing description of the specific embodiments will so fully reveal the general nature of the invention(s) that others can, by applying knowledge within the skill of the art, readily modify and/or adapt for various applications such specific embodiments, without undue experimentation, without departing from the general concept of the present invention(s). Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention(s) should not be limited by any of the above-described exemplary embodiments, but should be defined only in accordance with the following claims and their equivalents.

What is claimed is:

1. A method of making an article of apparel, the method comprising:
winding a first continuous thread around a plurality of projections to form a first thread layer comprising a plurality of thread lines, with each thread line extending between two respective projections; and
impregnating at least a portion of the first continuous thread with a flowable liquid polymer.

2. The method of claim 1, comprising winding a second continuous thread around a plurality of projections to form a second thread layer, the second thread layer comprising a plurality of thread lines, with each thread line extending between two respective projections.

3. The method of claim 2, comprising impregnating at least a portion of the second continuous thread with the flowable liquid polymer.

4. The method of claim 3, comprising positioning, after impregnating at least the portion of the second continuous thread with the flowable liquid polymer, a third layer between the first and second thread layers to form a layered structure, the third layer comprising a different material than the first and second thread layers.

5. The method of claim 4, wherein the different material comprises a foam material.

6. The method of claim 4, comprising conforming the layered structure to a shape of a mold.

7. The method of claim 6, comprising positioning the mold and the layered structure inside a vacuum bag; and removing air from the vacuum bag to bond the first and second thread layers and the third layer to one another via the flowable liquid polymer.

8. The method of claim 7, wherein the mold comprises a shoe last.

9. The method of claim 3, wherein the thread lines of the first thread layer are not bonded to one another and the thread lines of the second thread layer are not bonded to one another before impregnating at least the portions of the first and second continuous threads with the flowable liquid polymer, respectively.

10. The method of claim 3, wherein impregnating at least the portions of the first and second continuous threads with the flowable liquid polymer comprises soaking the first and second thread layers in the flowable liquid polymer.

11. The method of claim 1, wherein impregnating at least the portion of the first continuous thread with the flowable liquid polymer comprises applying the flowable liquid polymer to at least the portion of the first continuous thread while winding the first continuous thread around the plurality of projections.

12. The method of claim 1, wherein impregnating at least the portion of the first continuous thread with the flowable liquid polymer comprises applying the flowable liquid polymer to at least the portion of the first continuous thread before winding the first continuous thread around the plurality of projections.

13. The method of claim 1, wherein impregnating at least the portion of the first continuous thread with the flowable liquid polymer comprises applying the flowable liquid polymer to thread lines of the first thread layer after winding the first continuous thread around the plurality of projections.

14. The method of claim 1, wherein impregnating at least the portion of the first continuous thread with the flowable liquid polymer completely embeds individual thread lines of the first thread layer in the flowable liquid polymer.

15. The method of claim 1, wherein the flowable liquid polymer comprises an epoxy resin.

16. An article of apparel, comprising:
a first thread layer comprising a first perimeter edge and a plurality of first thread lines extending continuously from a first side of the first perimeter edge to a second side of the first perimeter edge;
a second thread layer comprising a second perimeter edge and a plurality of second thread lines extending continuously from a first side of the second perimeter edge to a second side of the second perimeter edge;
a third layer between the first and second thread layers, the third layer comprising a different material than the first and second thread layers; and
a polymer matrix bonding the first thread lines to one another, the second thread lines to one another, the first thread layer to the third layer, and the second thread layer to the third layer.

17. The article of apparel of claim 16, wherein the polymer matrix comprises an epoxy.

18. The article of apparel of claim 16, wherein the different material is a foam material.

19. The article of apparel of claim 16, wherein the first and second thread lines are non-woven and non-knitted thread lines, and wherein the first and second thread lines are non-embroidered thread lines.

20. The article of apparel of claim 16, wherein the first thread layer, the second thread layer, the third layer, and the polymer matrix form one or more of at least a portion of a shoe upper and at least a portion of a shoe sole.
